(19) United States
(12) Patent Application Publication
(10) Pub. No.: US 2006/0152765 A1
(43) Pub. Date: Jul. 13, 2006

(54) Image processing apparatus, image forming apparatus, image reading process apparatus, image processing method, image processing program, and computer-readable storage medium

(75) Inventor: Yasushi Adachi, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/328,088

(22) Filed: Jan. 10, 2006

(30) Foreign Application Priority Data
Jan. 11, 2005 (JP) 2005-004527

(51) Int. Cl. H04N 1/405

(52) U.S. Cl. 358/3.06

(57) ABSTRACT

The halftone frequency determining section is provided with a flat halftone discriminating section for extracting information of density distribution per segment block, and discriminating, based on the information of density distribution, whether the segment block is a flat halftone region in which density transition is low or of a non-flat halftone region in which the density transition is high; a threshold value setting section for setting a threshold value for use in binarization; a binarization section for performing the binarization in order to generate binary data of each pixel in the segment block according to the threshold value; a transition number calculating section for calculating out transition numbers of the binary data; and a maximum transition number averaging section for averaging the transition numbers which are of the segment block discriminated as the flat halftone region by the flat halftone discriminating section, and which are calculated out by a maximum transition number calculating section. A halftone frequency is determined (i.e., found out) based on only the maximum transition number average of the segment block discriminated as the flat halftone region. With this, it is possible to provide an image processing apparatus that can determine the halftone frequency highly accurately.

This Nonprovisional application claims priority under 35 U.S.C. § 119(a) on Patent Application No. 2005/004527 filed in Japan on Jan. 11, 2005, the entire contents of which are hereby incorporated by reference.

### FIELD OF THE INVENTION

The present invention relates to an image processing apparatus and image processing method in which a level of halftone frequency of an image signal obtained by document scanning is determined (i.e. found out) and process is suitably carried out based on the determined level of halftone frequency so as to improve quality of an outputted image. The image processing apparatus and image processing method are for use in digital copying machines, facsimile machines, and the like. The present invention further relates to an image reading process apparatus and image forming apparatus provided with the same, and to a program and a storage medium.

### BACKGROUND OF THE INVENTION

In digital color image input apparatuses (such as digital scanners, digital still cameras, and the like), tristimulus color information (R, G, B) is obtained via a solid-state image sensing element (CCD) that serves as a color separation system. The tristimulus color information, which is obtained in a form of analog signals, is then converted to digital signals, which are used as input signals that represent input color image data (color information). Segmentation is carried out so that display or output is carried out most suitably according to the signals obtained via the image input apparatus. The segmentation partitions a read document image into regions of equivalent properties so that each region can be processed with image process most suitable thereto. This makes it possible to reproduce a good-quality image.

In general, the segmentation of a document image includes discriminating a text region, a halftone region (halftone area) and photo region (in another words, continuous tone region (contone region), which is occasionally expressed as other region) in the document image to read, so that quality improvement process can be switched over for the respective regions determined. This attains higher reproduction quality of the image.

Furthermore, the halftone regions (image) have halftone varied from low frequencies to high frequencies, such as 65 line/inch, 85 line/inch, 100 line/inch, 120 line/inch, 133 line/inch, 150 line/inch, 175 line/inch, 200 line/inch, and the like. Therefore, various methods have been proposed for determining halftone frequencies so as to perform suitable process according to the determination.

For example, Japanese Unexamined Patent Publication, Tokukai, No. 2004-96535 (published on Mar. 25, 2004) discloses a method for determining a halftone frequency in a halftone region. In the method, a absolute difference in pixel value between a given pixel and a pixel adjacent to the given pixel is compared with a first threshold value so as to calculate out a number of pixels whose absolute difference in pixel value is greater than the first threshold value, and then the number of such pixels is compared with a second threshold value. The halftone frequency in the halftone region is determined based on the result of the comparison.

Moreover, Japanese Unexamined Patent Publications, Tokukai, No. 2004-102551 (published on Apr. 2, 2004), No. 2004-328292 (published on November 18) disclose methods for determining a halftone frequency based on a number of changeover (i.e., transition number) of the binary values of binary data of an input image.

For example, Japanese Unexamined Patent Publication No. 2004-96535 (published on Mar. 25, 2004) discloses a method in which absolute differences in pixel value between given pixels and pixels adjacent thereto are compared with a first threshold so as to calculate out (find out) a number of pixels (low-frequency halftone pixels) whose absolute differences in pixel value are larger than the first threshold, and then this number of the pixels is compared with a second threshold so as to obtain a comparison result on which the halftone frequency of a halftone region is judged (i.e., determined).

In the methods disclosed in Japanese Unexamined Patent Publications, Tokukai, No. 2004-102551 (published on Apr. 2, 2004), and No. 2004-328292 (published on November 18), the halftone frequency is determined based the number of changeover (i.e., transition number) of the binary values of the binary data of the input image, but no information of density distribution is taken into consideration. Therefore, with this method, binarization of a halftone region in which density transition is high is associated with the following problem (here, what is meant by the term “density” is “density in color, that is, pixel value in color”. So, for example, what is meant by the term “pixel density” is “density of color of the pixel”, but not “population of the pixels”).

FIG. 25(a) illustrates an example of one line along a main scanning direction of segment blocks in a halftone region in which the density transition is high. FIG. 25(b) illustrates the change of the density in FIG. 25(a). Here, it is put, for example, that a threshold value th1 illustrated in FIG. 25(b) is used as a threshold value for generation of binary data. In this case, as illustrated in FIG. 25(d), the segment blocks are discriminated into white pixel portions (that represent low-density halftone portion) and black pixel portions (that represent high-density halftone portion), thereby failing to attain such extraction in which black pixel portions (that represent a printed portion in the halftone) are extracted as illustrated in FIG. 25(c). With such extraction as illustrated in FIG. 25(d), it is impossible to generate binary data that reproduce halftone frequency accurately. This results in inaccurate halftone frequency determination.

### SUMMARY OF THE INVENTION

An object of the present invention is to provide an image processing apparatus and an image processing method which allows highly accurate halftone frequency determination, and further to provide (a) an image reading apparatus provided with the image processing apparatus and an image forming apparatus provided with the image processing apparatus, (b) an image processing program, and (c) a computer-readable storage medium in which the image processing program is stored.

In order to attain the object, an image processing apparatus according to the present invention is provided with a halftone frequency determining section for determining a halftone frequency of an inputted image, the image processing apparatus being arranged as follows: The halftone frequency determining section includes a flat halftone discriminating section for extracting information of density distribution per segment block consisting of a plurality of pixels, and discriminating, based on the information of density distribution, whether the segment block is a flat halftone region, which is a halftone region in which density transition is low or of a non-flat halftone region, which is a halftone region in which the density transition is high; an extracting section for extracting a feature of density transition between pixels of the segment block which the flat halftone discriminating section discriminates as the flat halftone region; and a halftone frequency estimating section for estimating the halftone frequency, based on the feature extracted by the extracting section.

Here, the segment block is not limited to a rectangular region and may have any kind of shape arbitrarily.

In this arrangement, the flat halftone discriminating section extracts information of density distribution per segment block consisting of a plurality of pixels, and discriminates, based on the information of density distribution, whether a given segment block is a flat halftone region (in which the density transition is low) or a non-flat halftone region (in which the density transition is high). Then, the extracting section extracts the feature of the density transition between pixels of the segment block which the flat halftone discriminating section discriminates as the flat halftone region. The halftone frequency is determined based on the feature.

As described above, the halftone frequency is determined based on the feature of the density transition of the segment block which is included in the flat halftone region in which the density transition is low. That is, the determination of the halftone frequency is carried out after removing the influence of the non-flat halftone region in which the density transition is high and which causes erroneous halftone frequency determination. In this way, accurate halftone frequency determination is attained.

For a fuller understanding of the nature and advantages of the invention, reference should be made to the ensuing detailed description taken in conjunction with the accompanying drawings.

### BRIEF DESCRIPTION OF THE DRAWINGS

FIG. 1, which illustrates one embodiment of the present invention, is a block diagram illustrating a halftone frequency determining section provided to an image processing apparatus.

FIG. 2 is a block diagram illustrating an arrangement of the image forming apparatus according to the embodiment of the present invention.

FIG. 3 is a block diagram illustrating an arrangement of a document type automatic discrimination section provided to the image processing apparatus according to the present invention.

FIG. 4(a) is an explanatory view illustrating an example of a block memory for use in convolution operation for detecting a text pixel by a text pixel detecting section provided to the document type automatic discrimination section.

FIG. 4(b) is an explanatory view illustrating an example of a filter coefficient for use in the convolution operation of input image data for detecting a text pixel by the text pixel detecting section provided to the document type automatic discrimination section.

FIG. 4(c) is an explanatory view illustrating an example of another filter coefficient for use in the convolution operation of input image data for detecting a text pixel by the text pixel detecting section provided to the document type automatic discrimination section.

FIG. 5(a) is an explanatory view illustrating an example of a density histogram as a result of detection of a page background pixel detecting section provided to the document type automatic discrimination section, where the detection detects page background pixels.

FIG. 5(b) is an explanatory view illustrating an example of a density histogram as a result of detection of a page background pixel detecting section provided to the document type automatic discrimination section, where the detection does not detect page background pixels.

FIG. 6(a) is an explanatory view illustrating an example of a block memory for use in calculation of a feature (sum of differences in pixel value between adjacent pixels, maximum density difference) for detecting the halftone pixel by a halftone pixel detecting section provided to the document type automatic discrimination section.

FIG. 6(b) is an explanatory view illustrating an example of distribution of a text region, halftone region, and photo region on a two dimensional plane whose axes are a sum of differences in pixel value between adjacent pixels and maximum density difference, which are features for detecting the halftone pixel.

FIG. 7(a) is an explanatory view illustrating an example of the input image data in which a plurality of photo regions coexist.

FIG. 7(b) is an explanatory view illustrating an example of a result of process performed on the example of FIG. 7(a) by a photo candidate pixel labeling section provided to the document type automatic discrimination section.

FIG. 7(c) is an explanatory view illustrating an example of a result of discrimination performed on the example of FIG. 7(b) by a photo type discrimination section provided to the document type automatic discrimination section.

FIG. 7(d) is an explanatory view illustrating an example of a result of discrimination performed on the example of FIG. 7(b) by a photo type discrimination section provided to the document type automatic discrimination section.

FIG. 8 is a flowchart illustrating a method of process of the document type automatic discrimination section (photo type operating section) illustrated in FIG. 3.

FIG. 9 is a flowchart illustrating a method of process of a labeling section provided to the document type automatic discrimination section illustrated in FIG. 3.

FIG. 10(a) is an explanatory view illustrating an example of a processing method of the labeling section in case where a pixel (upside pixel) adjacently on an upper side of a processing pixel is 1.

FIG. 10(b) is an explanatory view illustrating an example of a processing method of the labeling section in case where a pixel adjacently on the upper side of a processing pixel and a pixel (left side pixel) adjacently on a left side of a processing pixel are 1 but are labeled with different labels.

FIG. 10(c) is an explanatory view illustrating an example of a processing method of the labeling section in case where a pixel adjacently on the upper side of a processing pixel is 0 and a pixel adjacently on a left side of a processing pixel is 1.

FIG. 10(d) is an explanatory view illustrating an example of a processing method of the labeling section in case where a pixel adjacently on the upper side of a processing pixel and a pixel adjacently on a left side of a processing pixel are 0.

FIG. 11 is a block diagram illustrating another arrangement of the document type automatic discrimination section.

FIG. 12(a) is an explanatory view illustrating halftone pixels for which the halftone frequency determining section performs its process.

FIG. 12(b) is an explanatory view illustrating a halftone region for which the halftone frequency determining section performs its process.

FIG. 13 is a flowchart illustrating a method of the process of the halftone frequency determining section.

FIG. 14(a) is an explanatory view illustrating an example of a 120-frequency composite color halftone consisting of magenta dots and cyan dots.

FIG. 14(b) is an explanatory view illustrating G (Green) image data obtained from the halftone of FIG. 14(a).

FIG. 14(c) is an explanatory view illustrating an example of binary data obtained from the G image data of FIG. 14(b).

FIG. 15 is an explanatory view illustrating coordinates of the G image data of a segment block illustrated in FIG. 14(b).

FIG. 16(a) is a view illustrating an example of frequency distributions of maximum transition number averages of 85 line/inch documents (“85-line/inch doc.” in drawing), 133-line/inch documents (“133-line/inch doc.” in drawing), and 175-line/inch documents (“175-line/inch doc.” in drawing), where the maximum transition number averages are obtained only from the flat halftone regions.

FIG. 16(b) is a view illustrating an example of frequency distributions of maximum transition number averages of 85-line/inch documents, 133-line/inch documents, and 175-line/inch documents, where the maximum transition number averages are obtained from not only the flat halftone regions but also non-flat halftone regions.

FIG. 17(a) is an explanatory view illustrating a filter frequency property most suitable for the 85 line/inch.

FIG. 17(b) is an explanatory view illustrating a filter frequency property most suitable for the 133 line/inch.

FIG. 17(c) is an explanatory view illustrating a filter frequency property most suitable for the 175 line/inch.

FIG. 18(a) is an explanatory view illustrating an example of filter coefficients corresponding to FIG. 17(a).

FIG. 18(b) is an explanatory view illustrating an example of filter coefficients corresponding to FIG. 17(b).

FIG. 18(c) is an explanatory view illustrating an example of filter coefficients corresponding to FIG. 17(c).

FIG. 19(a) is an explanatory view illustrating an example of a filter coefficient for use in a low-frequency edge filter for use in detecting a character on halftone, the low-frequency edge filter being used according to the halftone.

FIG. 19(b) is an explanatory view illustrating another example of a filter coefficient for use in a low-frequency edge filter for use in detecting a character on halftone, the low-frequency edge filter being used according to the halftone.

FIG. 20 is a block diagram illustrating a modification of the halftone frequency determining section of the present invention.

FIG. 21 is a flowchart illustrating a method of process of the halftone frequency determining section as illustrated in FIG. 20.

FIG. 22 is a block diagram illustrating another modification of the halftone frequency determining section of the present invention.

FIG. 23 is a block diagram illustrating an arrangement of an image reading process apparatus according to a second embodiment of the present invention.

FIG. 24 is a block diagram illustrating an arrangement of the image processing apparatus when the present invention is realized as software (application program).

FIG. 25(a) is a view illustrating an example of one line along a main scanning direction of a segment block in a halftone region in which density transition is high.

FIG. 25(b) is a view illustrating relationship between the density transition and a threshold value in FIG. 25(a).

FIG. 25(c) is a view illustrating binary data, which correctly reproduces the halftone frequency of FIG. 25(a).

FIG. 25(d) is a view illustrating binary data generated using a threshold value th1 indicated FIG. 25(b).

### DESCRIPTION OF THE EMBODIMENTS

### First Embodiment

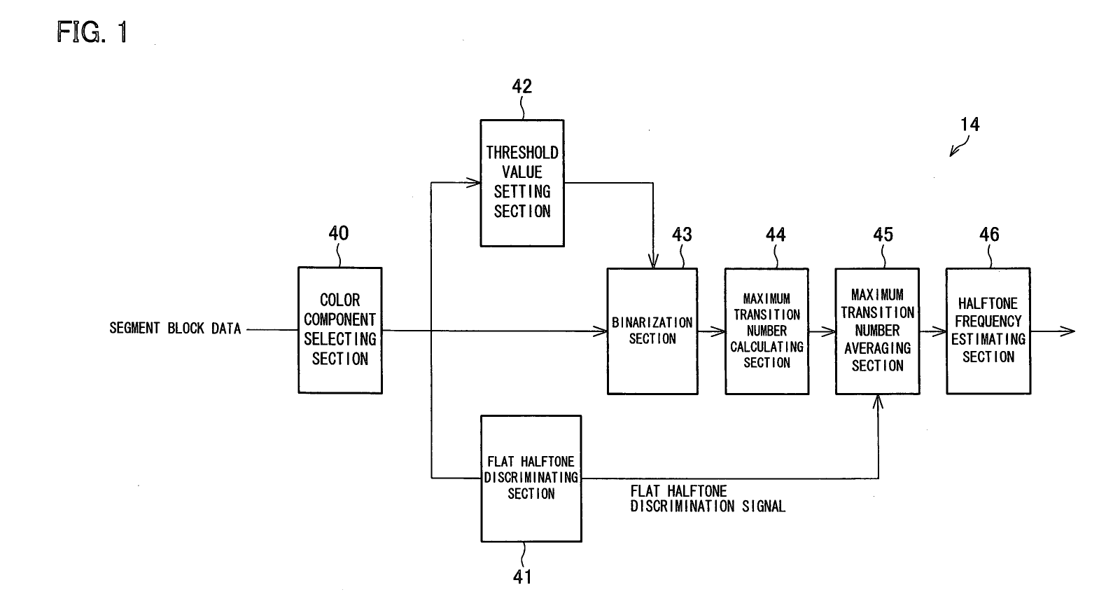

One embodiment of the present invention is described below referring to FIGS. 1 to 22.

<Overall Arrangement of Image Forming Apparatus>

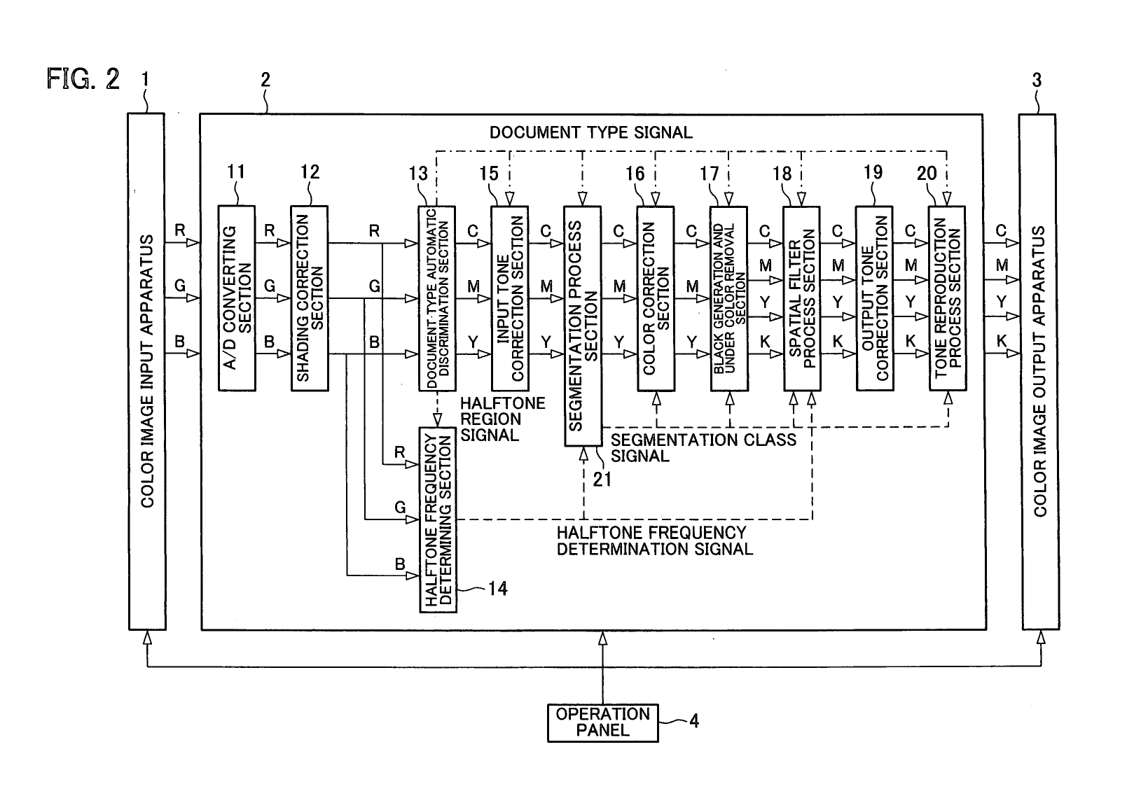

As illustrated in FIG. 2, an image forming apparatus according to the present embodiment is provided with a color image input apparatus 1, an image processing apparatus 2, a color image output apparatus 3, and an operation panel 4.

The operation panel 4 is provided with a setting key(s) for setting an operation mode of the image forming apparatus (e.g., digital copier), ten keys, a display section (constituted by a liquid crystal display apparatus or the like), and the like.

The color image input apparatus (reading apparatus) 1 is provided with a scanner section, for example. The color image input apparatus reads a reflection image from a document via a CCD (Charge Coupled Device) as RGB analog signals (R: red; G: green; and B: blue).

The color image output apparatus 3 is an apparatus for outputting a result of a given image process performed by the image processing apparatus 2.

The image processing apparatus 2 is provided with an A/D (analog/digital) converting section 11, a shading correction section 12, a document type automatic discrimination section 13, a halftone frequency determining section (halftone frequency determining means) 14, an input tone correction section 15, a color correction section 16, a black generation and under color removal section 17, a spatial filter process section 18, an output tone correction section 19, a tone reproduction process section 20, and a segmentation process section 21.

By the A/D converting section 11, the analog signals obtained via the color image input apparatus 1 are converted into digital signals.

The shading correction section 12 performs shading correction to remove various distortions which are caused in an illumination system, focusing system, and/or image pickup system of the color image input apparatus 2.

By the document type automatic discrimination section 13, the RGB signals (reflectance signals respectively regarding RGB) from which the distortions are removed by the shading correction section 12 are converted into signals (such as density signals) which are adopted in the image processing apparatus 2 and easy to handle for the image processing system. Further, the document type automatic discrimination section 13 performs discrimination of the obtained document image, for example, as to whether the document image is a text document, a printed photo document (halftone), a photo (contone), or a text/printed photo document (a document on which a character and a photo are printed in combination).

According to the document type discrimination, the document type automatic discrimination section 13 outputs a document type signal to the input tone correction section 15, the segmentation process section 21, the color correction section 16, the black generation and under color removal section 17, the spatial filter process section 18, and the tone reproduction process section 20. The document type signal indicates the type of the document image. Moreover, according to the document type discrimination, the document type automatic discrimination section 13 outputs a halftone region signal to the halftone frequency determining section 14. The halftone region signal indicates the halftone region.

The halftone frequency determining section 14 determines (i.e. finds out) the halftone frequency in the halftone region from a value of the feature that indicates the halftone frequency. The halftone frequency determining section 14 will be described later.

The input tone correction section 15 performs image quality adjustment process according to the discrimination made by the document type automatic discrimination section 13. Examples of the image quality adjustment process include: omission of page background region density, contrast adjustment, etc.

Based on the discrimination made by the document type automatic discrimination section 13, the segmentation process section 21 performs segmentation to discriminate the pixel in question as to whether the pixel in question is in a text region, a halftone region, a photo region (or another region). Based on the segmentation, the segmentation process section 21 outputs a segmentation class signal to the color correction section 16, the black generation and under color removal section 17, the spatial filter process section 18, and the tone reproduction process section 20. The segmentation class signal indicates to which type of region each pixel belongs.

In order to realize accurate color reproduction, the color correction section 16 performs color correction process for eliminating color impurity including useless absorption according to (due to) spectral characteristics of CMY (C: Cyan, M: Magenta, Y: Yellow) color materials that include unnecessary absorption components.

The black generation and under color removal section 17 performs black generating process to generate a black (K) signal from the three CMY color signals subjected to the color correction, and performs page background color removal process to remove from the CMY signal the K signal obtained by the black generating, thereby to obtain new CMY signals. As a result of the processes (black generating process and page background color removal process), the three colors signals are converted into four CMYK color signals.

The spatial filter process section 18 performs spatial filter process using a digital filter. The spatial filter process corrects spatial frequency property thereby to prevent blurring of output image and graininess deterioration.

The output tone correction section 19 performs output tone correction process to convert the signals such as the density signal into a halftone region ratio, which is a property of the image output apparatus.

The tone reproduction process section 20 performs tone reproduction process (intermediate tone generation process). The tone reproduction process decomposes the image into pixels and makes it possible to reproduce tones of the pixels.

An image region extracted as a black character, or as a color character in some cases, by the segmentation process section 21 is subjected to sharpness enhancement process performed by the spatial filter process section 18 to enhance the high halftone frequency thereby to be able to reproduce the black character or the color character with higher reproduction quality. In performing the above process, the spatial filter process section 18 performs the process based on the halftone frequency determination signal sent thereto from the halftone frequency determining section 14. This will be discussed later. In the intermediate tone generating process, binarization or multivaluing process for a high resolution screen suitable for reproducing the high halftone frequency is selected.

On the other hand, the region judged as the halftone by the segmentation process section 21 is subjected to a low-pass filter process by the spatial filter process section 18 to remove input halftone component. The spatial filter process section 18 performs the low-pass filter process based on the halftone frequency determination signal sent thereto from the halftone frequency determining section 14. This process will be described later. Moreover, in the intermediate tone generating process, the binarization or multivaluing process for a screen for high tone reproduction quality is performed. In the region segmented as a photo by the segmentation process section 21, the binarization or multivaluing process for a screen for high tone reproduction quality is performed.

The image date subjected to the above-mentioned processes is stored temporally in storage means (not illustrated) and read out to the color image output apparatus 3 at a predetermined timing. The above-mentioned processes are carried out by a CPU (Central Processing Unit).

The color image output apparatus 3 outputs the image data on a recording medium (for example, paper or the like). The color image output apparatus 3 is not particularly limited. For example, the color image output apparatus 3 may be an electronic photographic color image forming apparatus, an ink-jet color image forming apparatus, or the like.

The document type automatic discrimination section 13 is not inevitably necessary. The halftone frequency determining section 14 may be used in lieu of the document type automatic discrimination section 13. In this arrangement, pre-scanned image data or image data that has been subjected to the shading correction is stored in a memory such as a hard disc or the like. The judgment whether or not the image data includes a halftone region is made by using the stored image data, and the determination of the halftone frequency is carried out based on the judgment.

<Document Type Automatic Discrimination Section>

Next, the image process performed by the document type automatic discrimination section 13 is described, the image process being for detecting the halftone region which is to be subjected to the halftone frequency determination process.

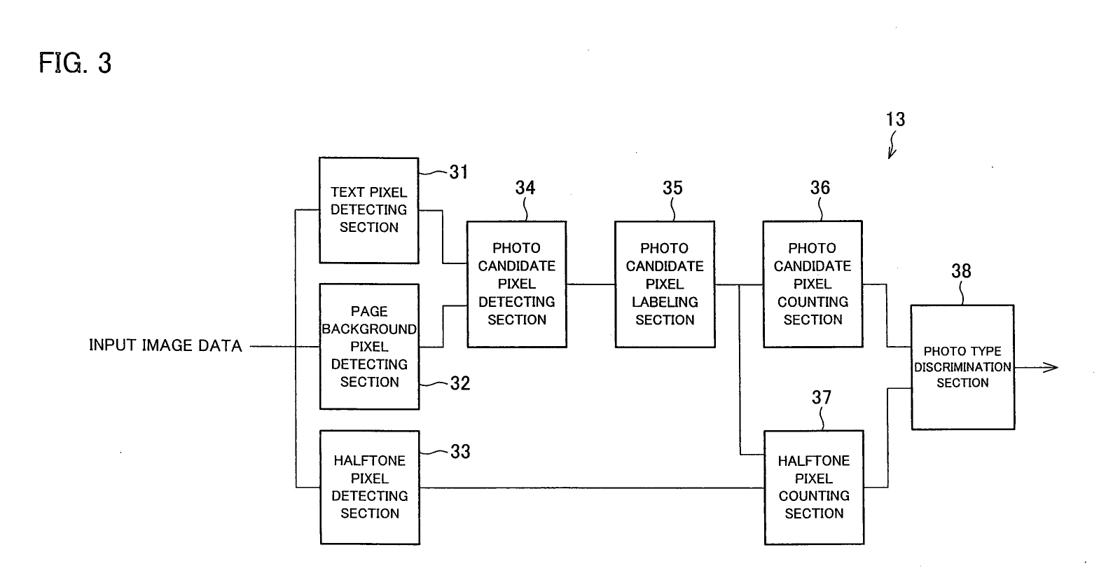

As illustrated in FIG. 3, the document type automatic discrimination section 13 is provided with a text pixel detecting section 31, a page background pixel detecting section 32, a halftone pixel detecting section 33, a photo candidate pixel detecting section 34, a photo candidate pixel labeling section 35, a photo candidate pixel counting section 36, a halftone pixel counting section 37, and a photo type discrimination section 38. Even though the following explains the image process referring to a case where CMY signals obtained by complementary color transformation of RGB signals are used, the image process may be arranged such that the RGB signals are used.

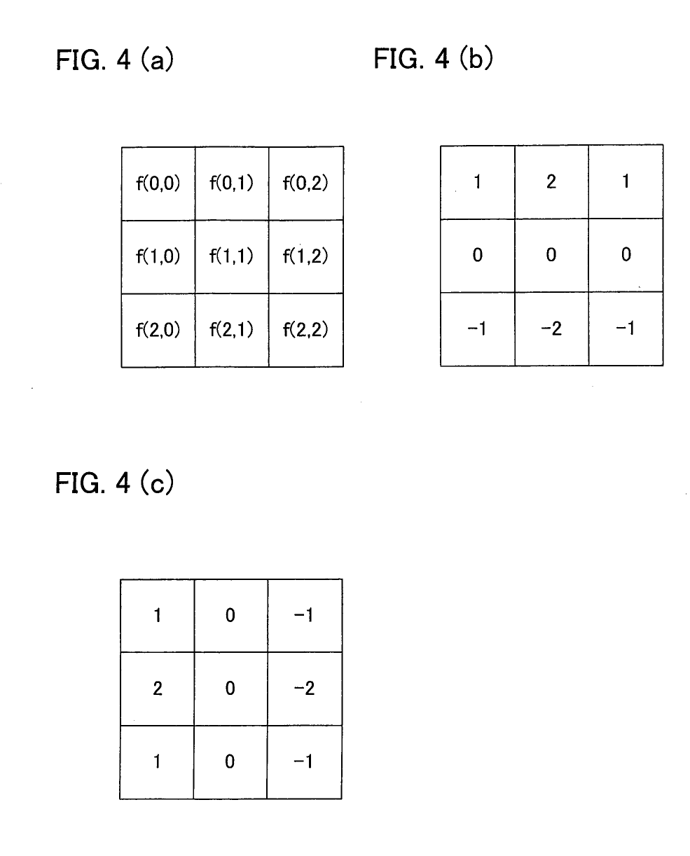

The text pixel detecting section 31 outputs a discriminating signal that indicates whether or not a given pixel in the input image data is in a character edge region. An example of the process of the text pixel detecting section is process using the following convolution operation results S1 and S2. The convolution operation results S1 and S2 is obtained by convolution operation of input image data (f(0,0) to f(2,2), which are respectively pixel densities of input image data) by using filter coefficients as illustrated in FIGS. 4(b) and 4(c), the input image data being stored in a block memory as illustrated in FIG. 4(a).
S1=1×f(0,0)+2×f(0,1)+1×f(0,2)−1×f(2,0)−2×f(2,1)−1×f(2,2)
S2=1×f(0,0)+2×f(1,0)+1×f(2,0)−1×f(0,2)−2×f(1,2)−1×f(2,2)
S=\sqrt{S1+S2}

If S was greater than a predetermined threshold value, a processing pixel (coordinates (1,1)) in the input image data stored in the block memory would be recognized as a text pixel present in the character edge region. All the pixels in the input image data is subjected to this process, thereby discriminating the text pixels in the input image data.

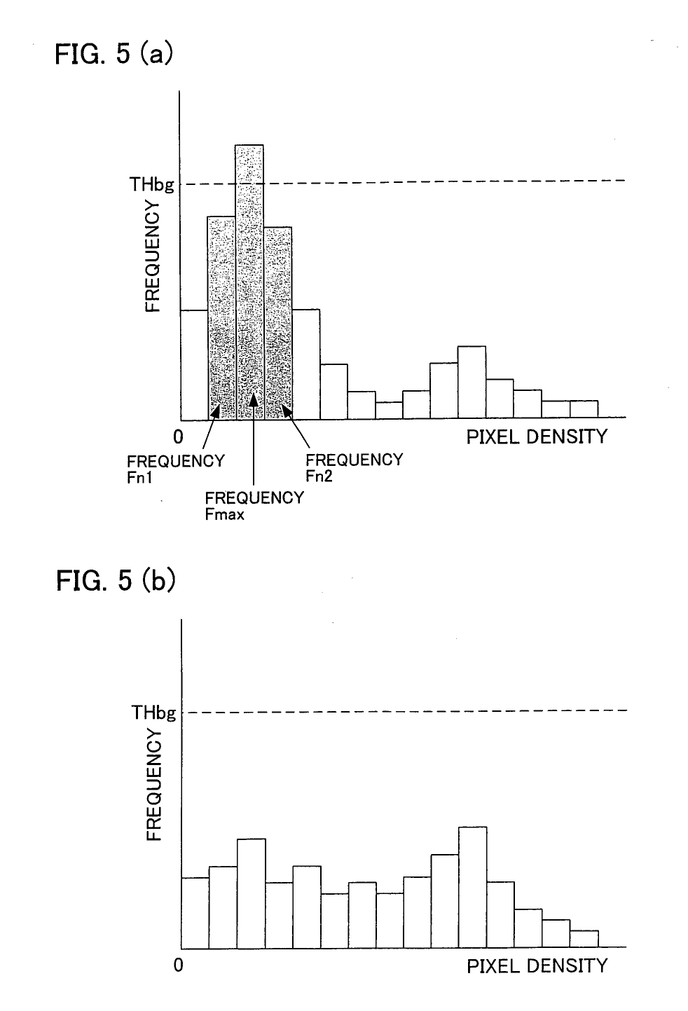

The page background pixel detecting section 32 outputs a discriminating signal that indicates whether or not a given pixel in the input image data is in the page background region. An example of the process of the page background pixel detecting section 32 is process using a density histogram as illustrated in FIGS. 5(a) and 5(b). The density histogram indicates a pixel density (e.g. of the M signal of the CMY signals obtained by complementary color translation) in the input image data.

In the following, the process steps are explained specifically referring to FIGS. 5(a) and 5(b).

Step 1: Find a maximum frequency (Fmax).

Step 2: If the Fmax is smaller than the predetermined threshold value (THbg), it is judged that the input image data includes no page background region.

Step 3: If the Fmax is equal to or greater than the predetermined threshold value (THbg), and if a sum of the Fmax and a frequency of a pixel density close to a pixel density (Dmax) which gives the Fmax is greater than the predetermined threshold value, it is judged that the input image data includes a page background region. (For example, the frequency of the pixel density close to the pixel density (Dmax) may be, e.g., Fn1 and Fn2 (meshing portions in FIG. 5(a)) where Fn1 and Fn2 are frequencies of pixel densities Dmax−1 and Dmax+1).

Step 4: If it is judged in Step 3 that the input image data includes the page background region, pixels having pixel densities in a vicinity of the Dmax, e.g., Dmax−5 to Dmax+5 are recognized as page background pixels.

The density histogram may be a simple density histogram in which density classes (e.g., 16 classes in which the 256 levels of pixel densities are divided) are used instead of individual pixel densities. Alternatively, a luminance histogram of luminance Y obtained by the following equation may be used.
Yⱼ=0.30Rⱼ+0.59Gⱼ+0.11Bⱼ
Yⱼ: Luminance of pixel in question,
Rⱼ,Gⱼ,Bⱼ: color component of pixel in question

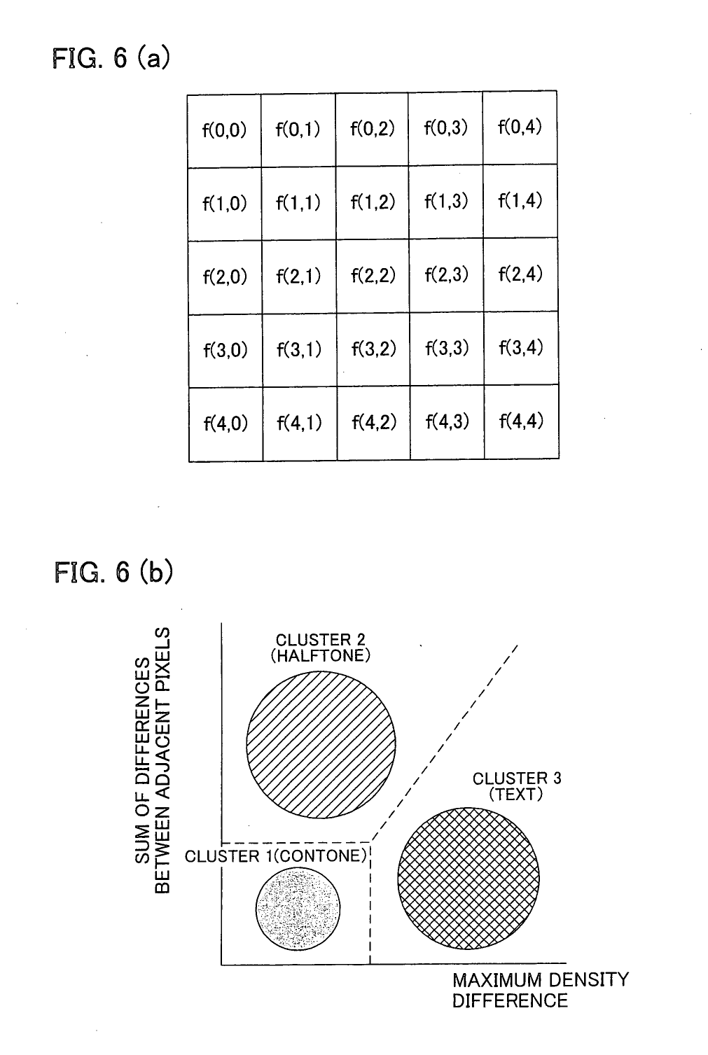

The halftone pixel detecting section 33 outputs a discriminating signal that indicates whether or not a given pixel in the input image data is in the halftone region. An example of the process of the halftone pixel detecting section 33 is process using adjacent pixel difference sum Busy (which is a sum of differences in pixel value of adjacent pixels) and a maximum density difference MD with respect to the input image data stored in the a block memory as illustrated in FIG. 6(a). In FIG. 6(a), (f(0,0) to f(4,4)) represent pixel densities of the input image data. The adjacent pixel difference sum Busy and a maximum density difference MD are described as follows:

$$Busy 1 = {\sum }_{i , j} \vert f ( i , j ) - f ( i , j + 1 ) \vert ( 0 \leq i \leq 5 , 0 \leq j \leq 4 )$$

$$Busy 2 = {\sum }_{i , j} \vert f ( i , j ) - f ( i + 1 , j ) \vert ( 0 \leq i \leq 4 , 0 \leq j \leq 5 )$$

Busy=max(busy1,busy2)
MaxD: maximum of f(0,0) to f(4,4)
MinD: minimum of f(0,0) to f(4,4)
MD=MaxD−MinD

Here, the Busy and MD are used to judge whether or not a processing pixel (coordinates (2,2)) is a halftone pixel present in the halftone region.

On a two dimensional plane in which the Busy and MD are the axes, the halftone pixels are distributed differently from pixels located in the other regions (such as text and photo), as illustrated in FIG. 6(b). Therefore, the judgment whether or not the processing pixel in the input image data is present in the halftone region is carried out by threshold value process regarding the Busy and MD calculated respectively for the individual processing pixels, using border lines (broken lines) indicated in FIG. 6(b) as threshold values.

An example of the threshold value process is given below.
Judge as halftone region if MD<70 and Busy>2000
Judge as halftone region if MD>70 and MD<Busy

By performing the above process for all the pixels in the input image data, it is possible to discriminate the halftone pixels in the input image data.

The photo candidate pixel detecting section 34 outputs a discrimination signal that indicates whether a given pixel is present in the photo candidate pixel region. For example, recognized as a photo candidate pixel is a pixel other than the text pixel recognized by the text pixel detecting section 31 and the page background pixel recognized by the page background pixel detecting section 32.

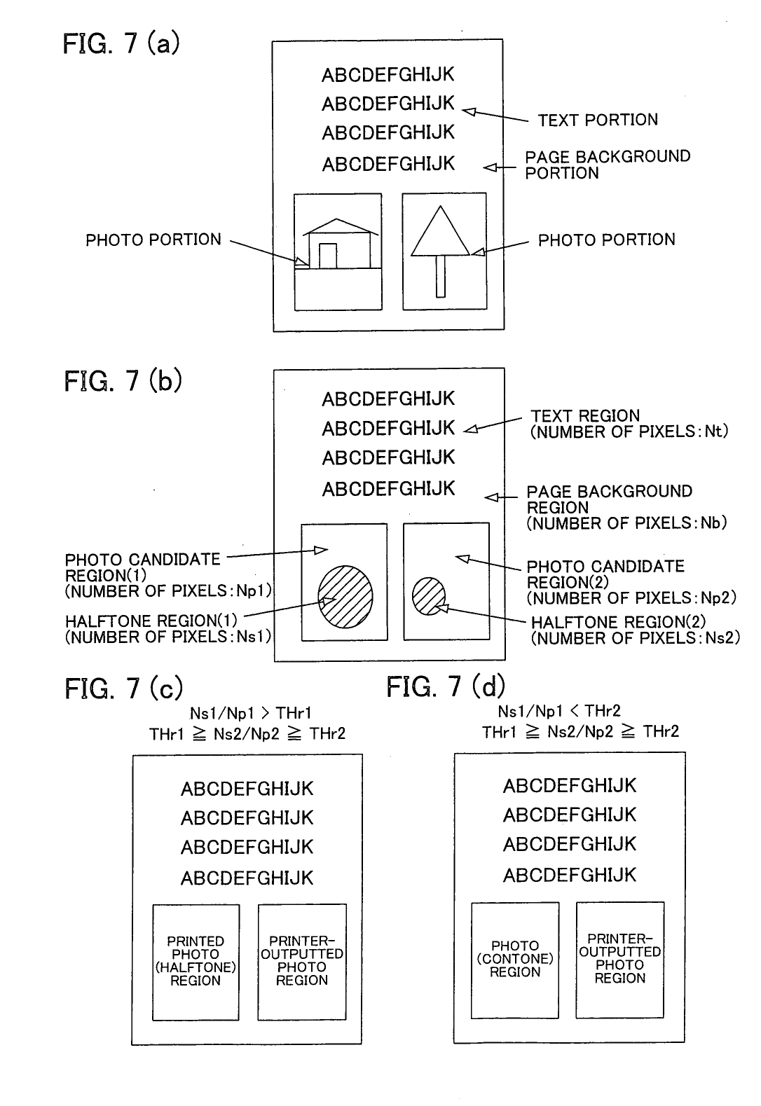

For input image data including a plurality of photo portions as illustrated in FIG. 7(a), the photo candidate pixel labeling section 35 performs labeling process with respect to a plurality of photo candidate regions that consist of photo candidate pixels discriminated by the photo candidate pixel detecting section 34. For instance, the plurality of photo candidate regions are labeled as a photo candidate region (1) and a photo candidate region (2) as illustrated in FIG. 7(b). This allows recognizing each photo candidate region individually. Here, for example, the photo candidate region is recognized as “1”, while other regions are recognized as “0”, and the labeling process is carried out per pixel. The labeling process will be described later.

The photo candidate pixel counting section 36 counts up pixels included in the respective photo candidate regions labeled by the photo candidate pixel labeling section 35.

The halftone pixel counting section 37 counts up pixels in the halftone regions (recognized by the halftone pixel detecting section 33) in the respective photo candidate regions labeled by the photo candidate pixel labeling section 35. For example, the halftone pixel counting section 37 gives a pixel number Ns1 by counting pixels consisting the halftone region (halftone region (1)) located in the photo candidate region (1) and a pixel number Ns2 by counting pixels consisting the halftone region (halftone region (2)) located in the photo candidate region (2).

The photo type discrimination section 38 judges whether the respective photo candidate regions are a printed photo (halftone region), photo (contone region) or printer-outputted photo (which is outputted (formed) by using a laser beam printer, ink-jet printer, thermal transfer printer or the like). For example, as illustrated in FIGS. 7(c) and 7(d), this discrimination is made by the following conditional equation using the photo candidate pixel number Np, the halftone pixel number Ns, and predetermined threshold values THr1 and THr2:
Condition 1:If Ns/Np>THr1, judge as printed photo (halftone)
Condition 2:If THr1≧Ns/Np≧THr2, judge as printer-output photo
Condition 3:If Ns/Np<THr2, judge as photo (contone)

The threshold values may be THr1=0.7 and THr2=0.3, for example.

Moreover, the discrimination result may be outputted per pixel, per region, or per document. Moreover, even though in the exemplary process the discrimination as to types regards photos, the discrimination may regards any type of document components such as graphic images, graphs, etc., except the characters and page background. Moreover, the photo type discrimination section 38 may be arranged to control switching-over of contents of the processes of the color correction section 16, the spatial filter process section 18, and the like based on a comparison between (a) a ratio of the halftone pixel number Ns to the photo candidate pixel number Np and (b) a predetermined threshold value, instead of judging whether the photo candidate region is a printed photo, a printer-outputted photo, or a photo.

In FIG. 7(c), the photo candidate region (1) is judged as a printed photo because the photo candidate region (1) satisfies the condition 1, whereas the photo candidate region (2) is judged as a printer-output photo region because the photo candidate region (2) satisfies the condition 2. In FIG. 7(d), the photo candidate region (1) is judged as a photo because the photo candidate region (1) satisfies the condition 3, whereas the photo candidate region (2) is judged as a printer-output photo region because the photo candidate region (2) satisfies the condition 2.

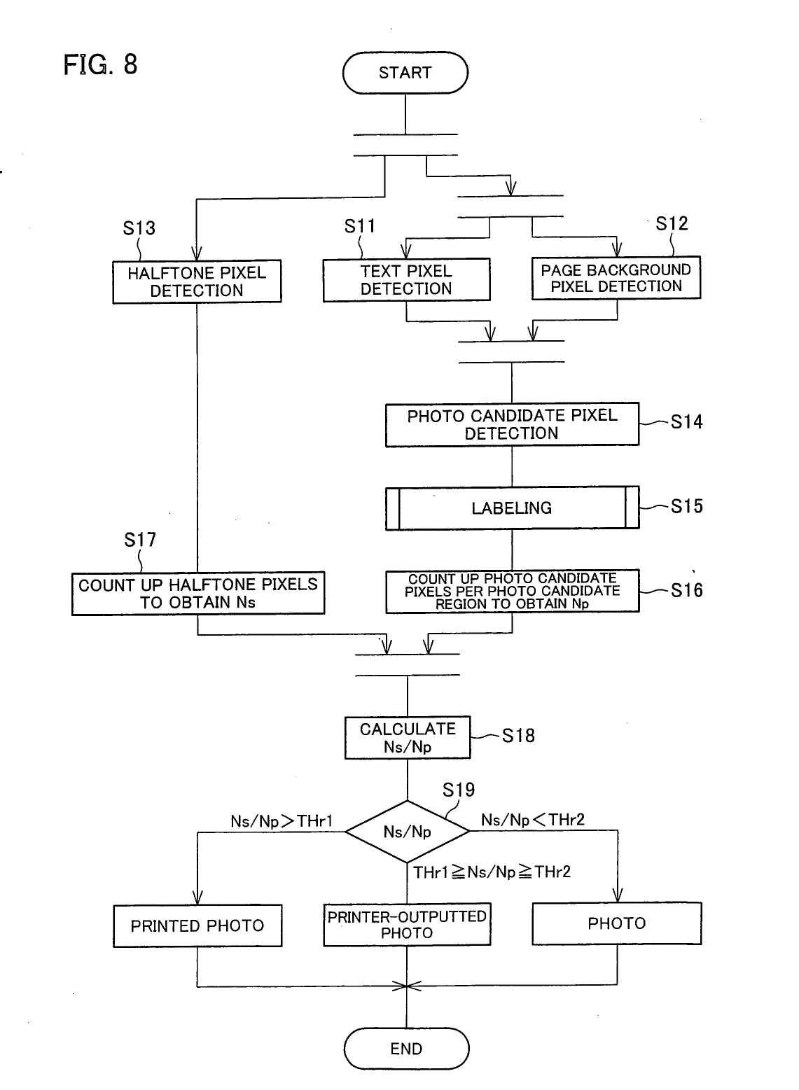

In the following, a method of an image type determining process performed by the document type automatic discrimination section 13 having the above arrangement is described referring to a flowchart illustrated in FIG. 8.

Firstly, based on the RGB density signals obtained by conversion of RGB signals (RGB reflectance signals) from which various distortions have been removed by the shading correction section 12 (see FIG. 2), the text pixel detecting process (S11), the page background pixel detecting process (S12), and the halftone pixel detecting process (S13) are performed in parallel. Here, the text pixel detecting process is carried out by the text pixel detecting section 31, the page background pixel detecting process is carried out by the page background pixel detecting section 32, and the halftone pixel detecting process is carried out by the halftone pixel detecting section 33. Therefore, detailed explanation of these processes is omitted here.

Next, based on results of the text pixel detecting process and the page background pixel detecting process, a photo candidate pixel detecting process is carried out (S14). The photo candidate pixel detecting process is carried out by the photo candidate pixel detecting section 34. Therefore, detailed explanation of this process is omitted here.

Next, the labeling process is carried out with respect to the detected photo candidate pixel (S15). The labeling process will be described later.

Then, based on a result of the labeling process, the photo candidate pixels are counted to obtain the photo candidate pixel number Np (S16). This counting is carried out by the photo candidate pixel counting section 36. Therefore, detailed explanation is omitted here.

In parallel with the processes S11 to S16, the halftone pixels are counted to obtain the halftone pixel number Ns based on a result of the halftone pixel detecting process at S13 (S17). This counting is carried out by the halftone pixel counting section 37. Therefore, detailed explanation of this process is omitted here.

Next, based on the photo candidate pixel number Np obtained at S16 and the halftone pixel number Ns obtained at S17, a ratio of the halftone pixel number Ns to the photo candidate pixel number Np (i.e. Ns/Np) is calculated out (S18).

Then, from Ns/Np obtained at S18, the photo candidate region is judged whether it is a printed photo, a printer-outputted photo, or a photo (Sl9).

The processes at S18 and S19 are carried out by the photo type discrimination section 38. Therefore, detailed explanation on these processes is omitted here.

In the following, the labeling process is described.

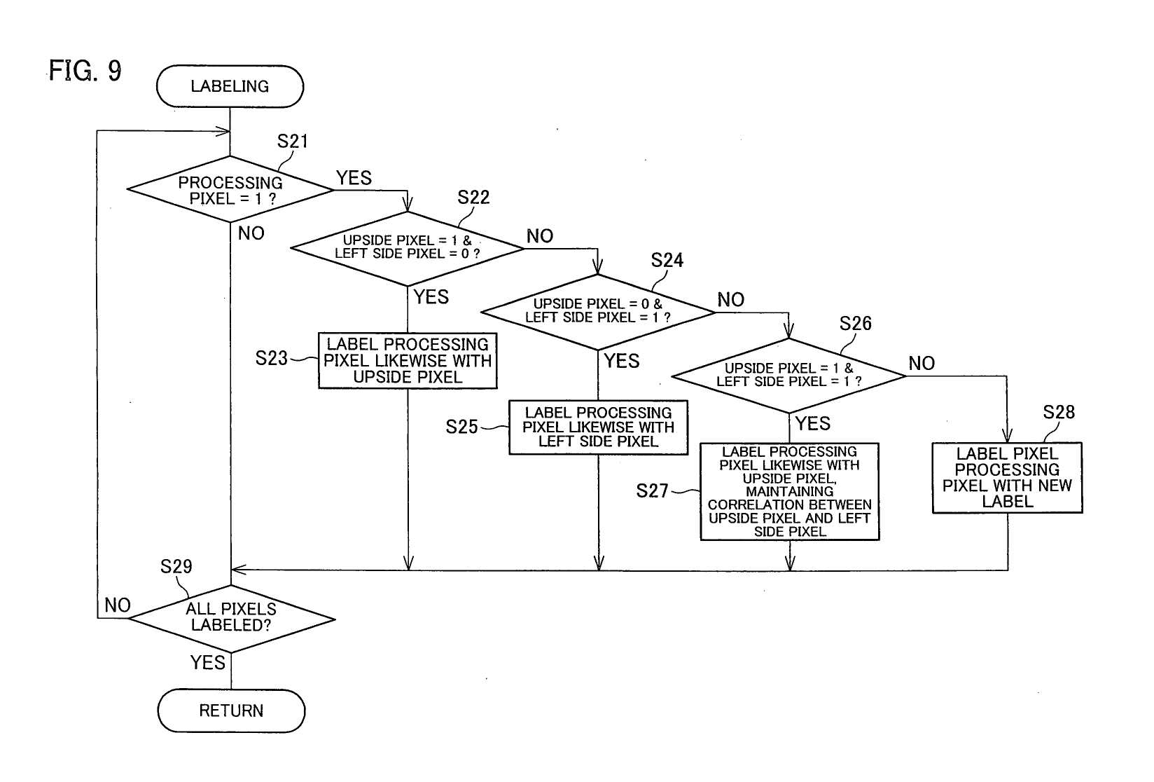

In general, the labeling process is a process to label a cluster of equivalent and continuous foreground pixels (=1) with a label likewise, and label a cluster of other equivalent and continuous foreground pixels with a different label likewise. (see Image process standard text book of CG-APTS, p.262 to 268). Various kinds of labeling process have been proposed. In the present embodiment, a labeling system in which scanning is carried out twice is employed. A method of the labeling process is described below referring to a flowchart illustrated in FIG. 9.

To begin with, values of pixels are measured from an uppermost and leftmost pixel in a raster scanning order (S21). If the value of a processing pixel=1, it is judged that whether or not a pixel (upside pixel) adjacently on an upper side of the processing pixel is 1 and whether or not a pixel (left side pixel) adjacently on a left side of the processing pixel is 0 (S22).

Here, if the pixel adjacently on the upper side of the processing pixel=1 and the pixel adjacently on the left side of the processing pixel=0 at S22, procedure 1 is carried out. The procedure 1 is as follows.

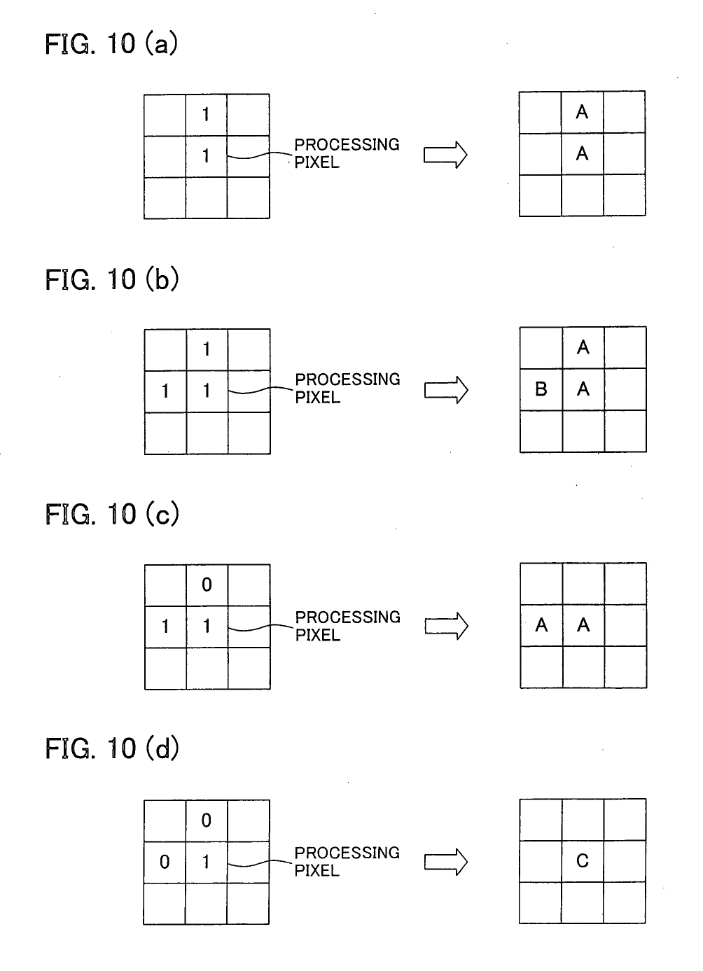

Procedure 1: As illustrated in FIG. 10(a), if the processing pixel=1, and if the pixel adjacently on the upper side thereof is labeled with a label (A), the processing pixel is labeled with the label (A) likewise (S23). Then, the process goes to S29, at which it is judged whether all the pixels are labeled or not. If all the pixels are labeled at S29, the process goes to S16 (illustrated in FIG. 8) at which the counting to obtain the photo candidate pixel number Np is carried out for every photo candidate region.

Moreover, if the pixel adjacently on the upper side of the processing pixel=1 and the pixel adjacently on the left side of the processing pixel≠0 at S22, it is judged whether the pixel adjacently on the left side of the processing pixel is 1 or not (S24).

Here, if the pixel adjacently on the upper side of the processing pixel=0 and the pixel adjacently on the left side of the processing pixel=1 at S24, procedure 2 is carried out. The procedure 2 is as follows.

Procedure 2: as illustrated in FIG. 10(c), if the pixel adjacently on the upper side thereof=0 and the pixel adjacently on the left side thereof=1, the processing pixel is labeled with the label (A) likewise with the pixel adjacently on the left side thereof (S25). Then, the process moves to S29, at which it is judged whether all the pixels are labeled or not. If all the pixels are labeled at S29, the processes goes to S16 (illustrated in FIG. 8) at which the counting to obtain the photo candidate pixel number Np is carried out for every photo candidate region.

Moreover, if the pixel adjacently on the upper side of the processing pixel≠0 and the pixel adjacently on the left side of the processing pixel≠1 at S24, it is judged whether or not the pixel adjacently on the upper side of the processing pixel=1 and whether or not the pixel adjacently on the left side of the processing pixel=1 (S26).

If the pixel adjacently on the upper side of the processing pixel=1 and the pixel adjacently on the left side of the processing pixel=1 at S26, procedure 3 is carried out. The procedure 3 is as follows.

Procedure 3: As illustrated in FIG. 10(b), if the pixel adjacently on the left side thereof is also “1” and is labeled with a label (B) unlikewise with the pixel adjacently on the upper side of the processing pixel, the processing pixel is labeled with the label (A) likewise with the pixel adjacently on the upper side thereof, while keeping correlation between the label (B) of the pixel adjacently on the left side thereof and the label (A) of the pixel adjacently on the upper side thereof (S27). Then, the process moves to S29, at which it is judged whether all the pixels are labeled or not. If all the pixels are labeled at S29, the process goes to S16 (illustrated in FIG. 8) at which the counting to obtain the photo candidate pixel number Np is carried out for every photo candidate region.

Further, if the pixel adjacently on the upper side of the processing pixel≠1 and the pixel adjacently on the left side of the processing pixel≠1 at S26, procedure 4 is carried out. The procedure 4 is as follows:

Procedure 4: As illustrated in FIG. 10(d), if both the pixels adjacently on the upper side and on the left side thereof=0, the processing pixel is labeled with a new label (C) (S28). Then, the process moves to S29, at which it is judged whether all the pixels are labeled or not. If all the pixels are labeled at S29, the process goes to S16 (illustrated in FIG. 8) at which the counting to obtain the photo candidate pixel number Np is carried out for every photo candidate region.

In the case where plural kinds of labels are used to label the pixels, the above-mentioned rule is applied so that like pixels are labeled with a label likewise.

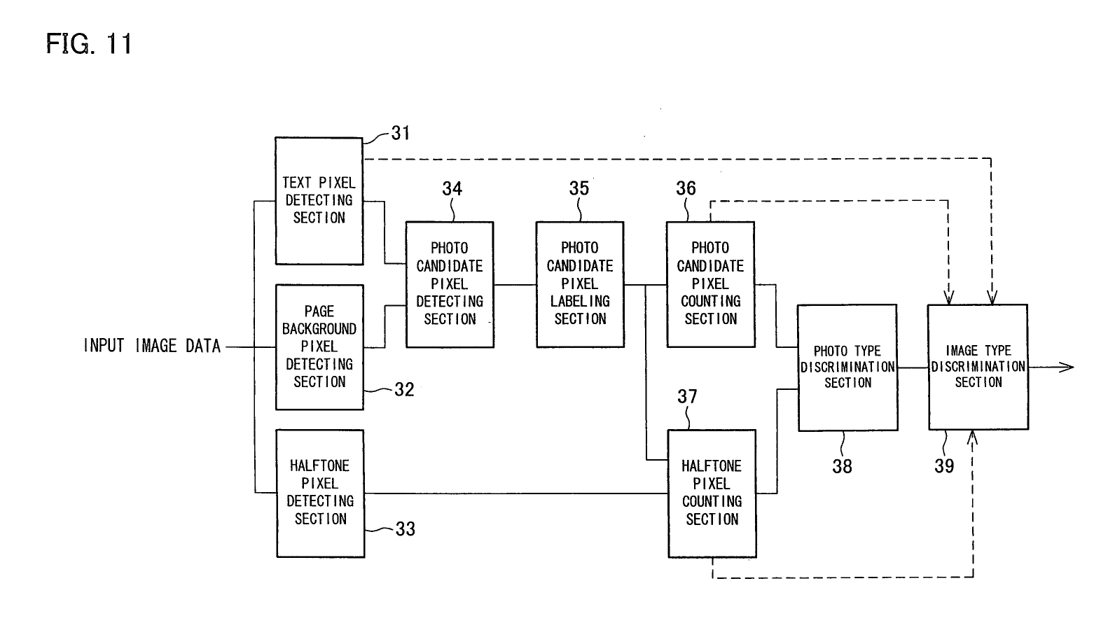

Moreover, the arrangement illustrated in FIG. 3 may be arranged not only to discriminate the photo regions, but also to discriminate the type of the whole image. In this case, the arrangement illustrated in FIG. 3 is provided with an image type discrimination section 39 in the downstream of the photo type discrimination section 38 (see FIG. 11). The image type discrimination section 39 finds a ratio Nt/Na (which is a ratio of the text pixel number to total number of the pixels), a ratio (Np−Ns)/Na (which is a ratio of a difference between the photo candidate pixel number and halftone pixel number to the total number of the pixels), and a ratio Ns/Na (which is a ratio of the halftone pixel number to the total number of the pixels), and compares these ratios respectively with predetermined threshold values THt, THp, and THs. Based on the comparisons and the result of the process of the photo type discrimination section 38, the image type discrimination section 39 performs the discrimination with respect to the whole image to find the type of the image overall. For example, if the ratio Nt/Na is equal to or more than the threshold value, and if the photo type discrimination section 38 judges that the document is a printer-output photo, the image type discrimination section 39 judges that the document is a document on which text and printer-outputted photo coexist.

<Halftone Frequency Determining Section>

The following describes the image process (halftone frequency determining process) performed by the halftone frequency determining section (halftone frequency determining means) 14. The halftone frequency determining process is a characteristic feature of the present embodiment.

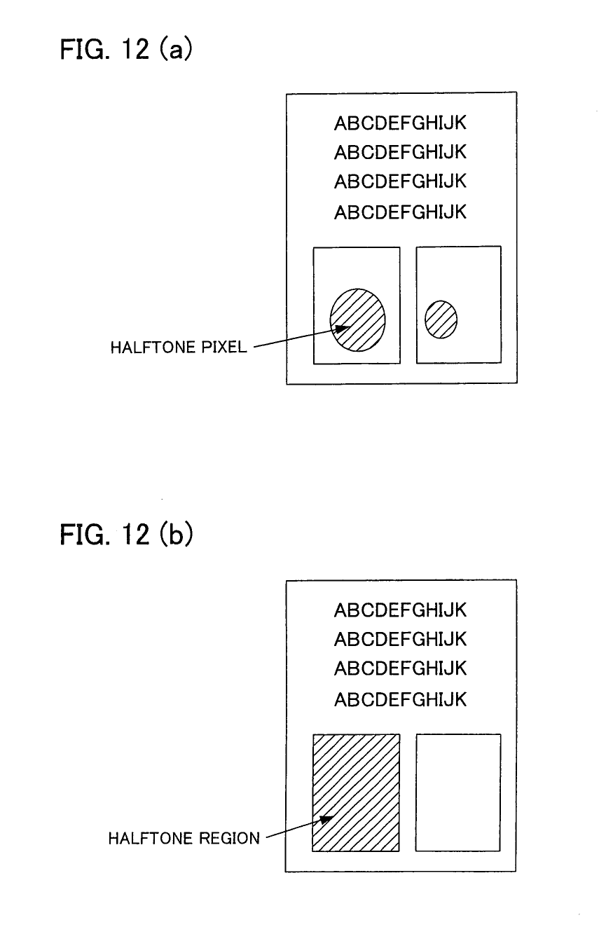

The process performed by the halftone frequency determining section 14 is carried out only with respect to the halftone pixels (see FIG. 12(a)) detected during the process of the document type automatic discrimination section 13 or the halftone region (see FIG. 12(b)) detected by the document type automatic discrimination section 13. The halftone pixels illustrated in FIG. 12(a) corresponds to the halftone region (1) illustrated in FIG. 7(b), and the halftone region illustrated in FIG. 12(b) corresponds to the printed photo (halftone) region illustrated in FIG. 7(c).

The halftone frequency determining section 14 is, as illustrated in FIG. 1, provided with a color component selecting section 40, a flat halftone discriminating section (flat halftone discriminating means) 41, a threshold value setting section (extracting means, threshold value setting means) 42, binarization section (extracting means, binarization means) 43, a maximum transition number calculating section (extracting means, transition number calculating means) 44, a maximum transition number averaging section (transition number extracting means) 45, and a halftone frequency estimating section (halftone frequency estimating means) 46.

These sections perform their processes per segment block which is constituted of the processing pixel and pixels nearby the processing pixel and which has a size of M pixel×N pixel where M and N are integers predetermined experimentally. These sections output their results per pixel or per segment block.

The color component selecting section 40 finds respective sums of density differences for the respective RGB components (Hereinafter, the sums of the density differences are referred to as “busyness”). By the color component selecting section 40, image data having a color component having a largest busyness among them is selected as image data to be outputted to the flat halftone discriminating section 41, the threshold value setting section 42, and the binarization section 43.

The flat halftone discriminating section 41 performs discrimination of the segment blocks as to whether the respective segment blocks are in flat halftone or in non-flat halftone. The flat halftone is a halftone in which density transition is low. The non-flat halftone is a halftone in which density transition is high. The flat halftone discriminating section 41 calculates out a absolute difference sum subm1, a absolute difference sum subm2, a absolute difference sum subs1, and an absolute difference sum subs2 in a given segment block. The absolute difference sum subm1 is a sum of absolutes of differences between adjacent pairs of pixels the right one of which is greater in density than the left one. The absolute difference sum subm2 is a sum of absolutes of differences between adjacent pairs of pixels the right one of which is less in density than the left one. The absolute difference sum subs1 is a sum of absolutes of differences between adjacent pairs of pixels the upper one of which is greater in density than the lower one. The absolute difference sum subs2 is a sum of absolutes of differences between adjacent pairs of pixels the upper one of which is less in density than the lower one. Moreover, the flat halftone discriminating section 41 finds busy and busy_sub from Equation (1), and judges that the segment block is a flat halftone portion, if the obtained busy and busy_sub satisfy Equation (2). TH pair in Equation (2) is a value predetermined via experiment. Further, the flat halftone discriminating section 41 outputs a flat halftone discrimination signal flat (a flat halftone discrimination signal flat of 1 indicates flat halftone, whereas a flat halftone discrimination signal flat of 0 indicates non-flat halftone).

$$\begin{matrix}\begin{matrix}If {{\vert sumb 1 - subm 2 \vert}_{busy = subm 1 + subm 2}}_{busy\_sub = \vert subm 1 - subm 2 \vert} > \vert subs 1 - subs 2 \vert \\ If {{\vert sumb 1 - subm 2 \vert}_{busy = subs 1 + subs 2}}_{busy\_sub = \vert subs 1 - subs 2 \vert} \leq \vert subs 1 - subs 2 \vert\end{matrix} \} & Equation 1 \\ busy\_sub {/}_{busy} < THpair & Equation 2\end{matrix}$$

The threshold value setting section 42 calculates out an average density ave of the pixels in the segment block, and sets the average density ave as the threshold value th1 that is employed in binarization of the segment block.

In a case where the threshold value employed in the binarization is a fixed value close to an upper limit or a lower limit of the density, the fixed value would be out of the density range of the segment block or close to a maximum value or minimum value of the density range, depending on width of the density range. If the fixed value was out of the density range or close to the maximum value or minimum value of the density range, binary data obtained using the fixed value could not be binary data that correctly reproduces the halftone frequency.

However, the average density of the pixels in the segment block is set as the threshold value by the threshold value setting section 42. The threshold value set is approximately in a middle of the density range. With this, it is possible to obtain the binary data that reproduces the halftone frequency correctly.

With the threshold value th1 set by the threshold value setting section 42, the binarization section 43 performs binarization of the pixels in the segment block, thereby to obtain the binary data.

The maximum transition number calculating section 44 calculates out a maximum transition number of the segment block from a transition number (m rev) of the binary data obtained from main scanning lines and sub scanning lines, i.e., how many times the binary data, obtained from main scanning lines and sub scanning lines, is switched over.

The maximum transition number averaging section 45 calculates out an average m rev_ave of the transition numbers (m rev) of all those segment blocks in the halftone region for which the flat halftone discrimination signal outputted from the flat halftone discriminating section 41 is 1, the transition numbers (m rev) having been calculated out by the maximum transition number calculating section 44. The transition number and the flat halftone discrimination signal obtained for each segment block may be stored in the maximum transition number averaging section 45 or may be stored in a memory provided in addition.

The halftone frequency estimating section 46 estimates the frequency of the input image by comparing (a) the maximum transition number average m rev_ave calculated by the maximum transition number averaging section 45 with (b) theoretical maximum transition numbers predetermined for halftone documents (printed photo document) of respective frequencies.

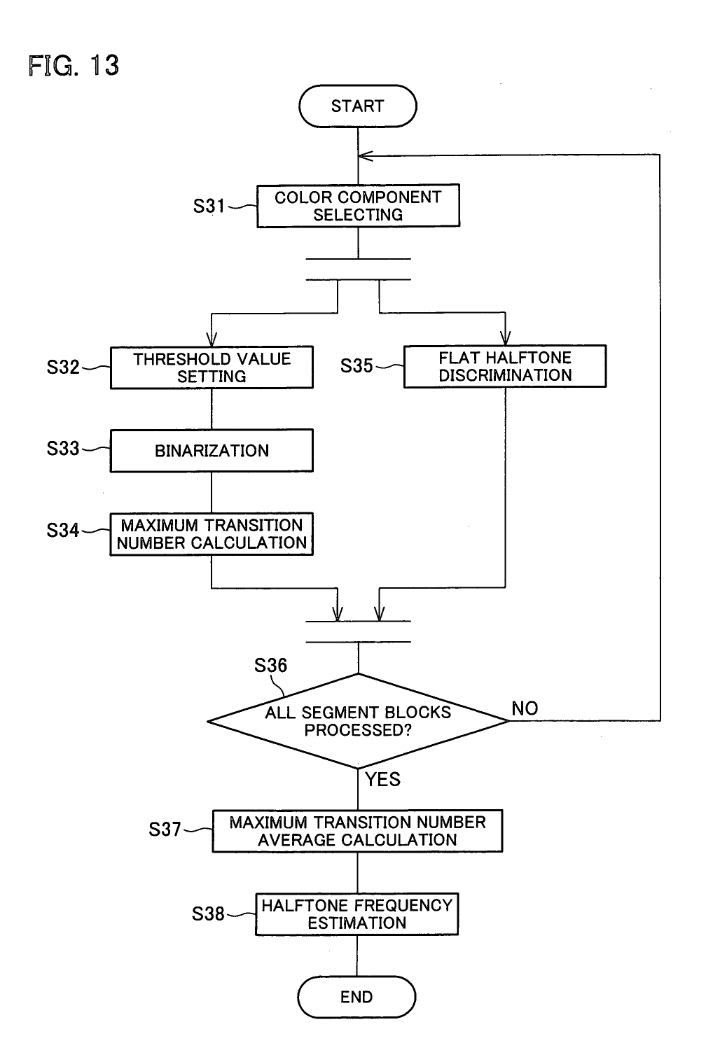

In the following, a method of the halftone frequency determining process of the halftone frequency determining section 14 having the above arrangement is described below referring to a flowchart illustrated in FIG. 13.

To begin with, as to the halftone pixel or segment block of the halftone region, which is detected by the document type automatic discrimination section 13, the color component selecting section 40 selects the color component having the largest busyness (S31).

Next, for the segment block, the threshold value setting section 42 calculates out the average density ave of the color component selected by the color component selecting section 40, and sets the average density ave as the threshold value th1 (S32).

Next, the binarization section 43 performs the binarization of each pixel in the segment block, using the threshold value th1 obtained by the threshold value setting section 42 (S33).

After that, the maximum transition number calculating section 44 calculates out (finds out) the maximum transition number in the segment block (S34).

In parallel with S32, S33, and S34, the flat halftone discriminating section 41 performs the flat halftone discriminating process for discriminating whether the segment block is in halftone or in non-halftone, and outputs the flat halftone discrimination signal flat to the maximum transition number averaging section 45 (S35).

Then, it is judged whether or not the processes are done for all the segment blocks (S36). If not, the processes of S31 to S35 are repeated for a segment block to be processed next.

If the processes are done for all the segment blocks, the maximum transition number averaging section 45 calculates out the average of the maximum transition numbers, calculated at S34, of all those segment blocks in the halftone region for which the flat halftone discrimination signal flat is 1 (S37).

Then, based on the maximum transition number average calculated out by the maximum transition number averaging section 45, the halftone frequency estimating section 46 estimates the halftone frequency of the halftone region (S38). Then, the halftone frequency estimating section 46 outputs the halftone frequency determination signal that indicates the halftone frequency determined by its estimation. By this, the halftone frequency determining process is completed.

Next, a concrete example of the processes dealing with actual image data and its effect are explained below. Here, it is assumed that the segment block is in size of 10×10 pixels.

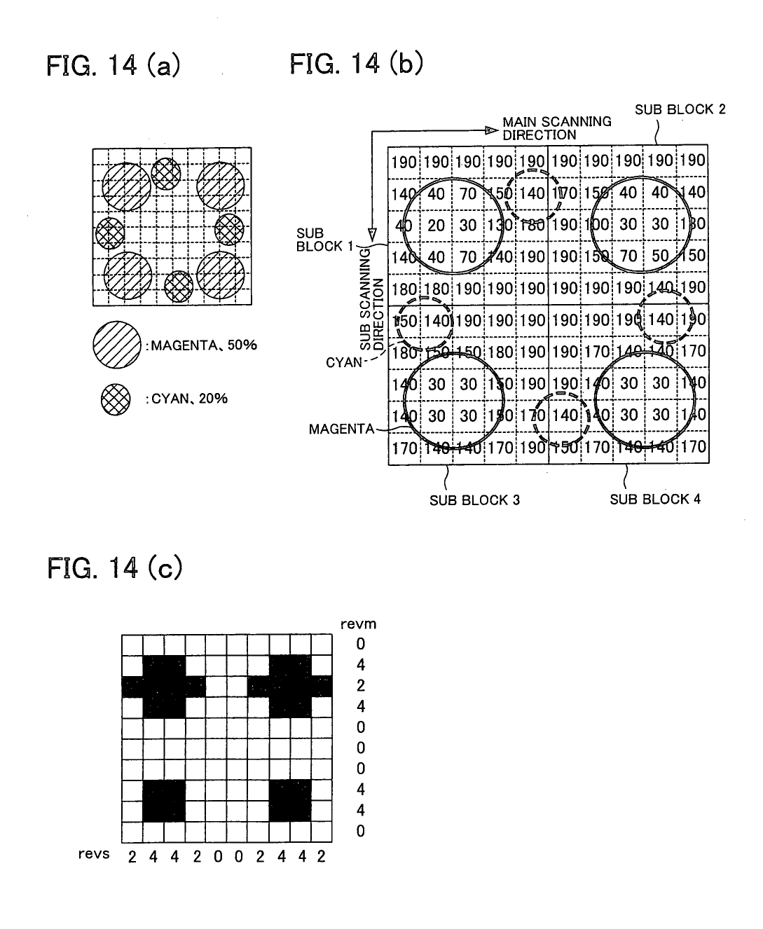

FIG. 14(a) illustrates an example of a halftone of 120 line/inch in composite color, consisting of magenta dots and cyan dots. If the input image is in composite color halftone, it is desirable that, among CMY in each segment block, only the color having a larger density change (busyness) than the rest be taken into consideration and the halftone frequency of the color be used for determining the halftone frequency of the document. Further, it is desirable that dots of the color having the larger density transition than the rest are processed by using a channel (signal of the input image data) most suitable for representing the density of the dots of the color. Specifically, for a composite color halftone consisted mainly of magenta dots as illustrated in FIG. 14(a), G (green) image (complementary color for magenta) is used, which is most suitable for processing magenta. This makes it possible to perform halftone frequency determining process which is based on substantially only the magenta dots. In the segment block as illustrated in FIG. 14(a), G image data is the image data having the larger busyness than the other image data. Thus, the color component selecting section 40 selects the G image data as image data to be outputted to the flat halftone discriminating section 41, the threshold value setting section 42, and the binarization section 43.

FIG. 14(b) is density of G image data in each pixel in the segment block illustrated in FIG. 14(a). The flat halftone discriminating section 41 subjects the G image data as illustrated in FIG. 14(b) to the following process.

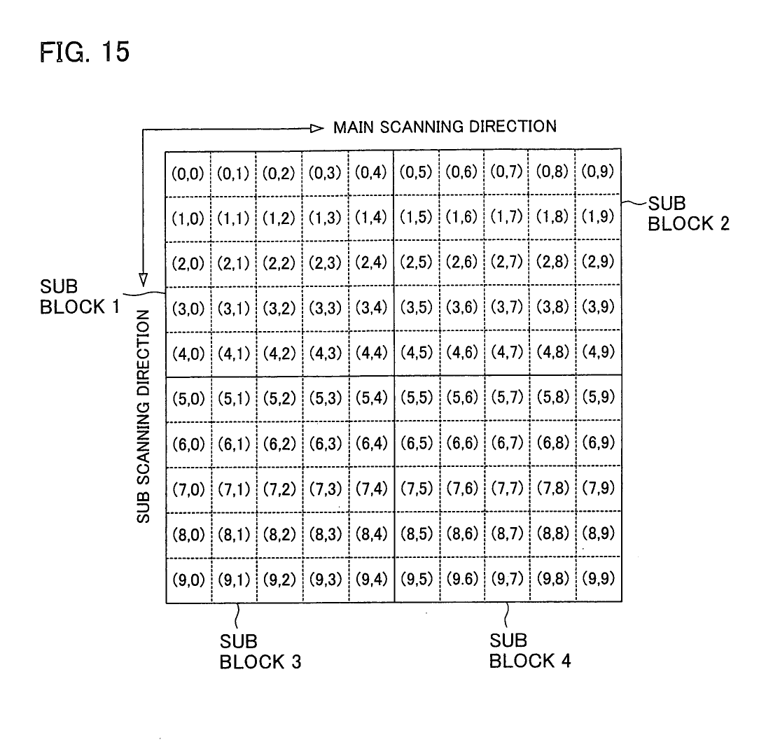

FIG. 15 illustrates coordinates of the G image data in the segment block illustrated in FIG. 14(b).

For each line in the main scanning direction, the absolute difference sum subm1(i), which is the sum of the absolute differences between density of a pair of adjacent pixels the right one of which is greater in density than the left one, is calculated as follows. Here, the calculation for the second line from the top is explained by way of example. In the second line, the pairs of the coordinates (1,1) and (1,2), (1,2) and (1,3), (1,4) and (1,5), and (1,8) and (1,9) are such pairs of adjacent pixels, the right one of which is greater than or equal to the left one in density. Hence, the absolute difference sum subm1(1) is as follows:

$$subm 1 ( 1 ) = \vert 70 - 40 \vert + \vert 150 - 70 \vert + \vert 170 - 140 \vert + \vert 140 - 40 \vert = 240.$$

where subm1(i) represents the subm1 at a sub-scanning direction coordinates i.

For each line in the main scanning direction, the absolute difference sum subm2(i), which is the sum of the absolute differences between density of a pair of adjacent pixels, the right one of which is less in density than (or equal in density to) the left one, is calculated as follows. Here, the calculation for the second line from the top is explained by way of example. In the second line, the pairs of the coordinates (1,0) and (1,1), (1,3) and (1,4), (1,6) and (1,7), and (1,7) and (1,8) are such pairs of adjacent pixels, the right one of which is less in density than the left one. Hence, the absolute difference sum subm2(1) is as follows:

$$subm 2 ( 1 ) = \vert 40 - 140 \vert + \vert 140 - 150 \vert + \vert 150 - 170 \vert + \vert 40 - 40 \vert = 240.$$

where subm2(i) represents the subm2 at a sub-scanning direction coordinates i.

From the following equation using subm1(0) to subm1(9) and subm2(0) to subm2(9) calculated in the same manner, subm1, subm2, busy, busy_sub are calculated out.

$$\begin{matrix}subm 1 = {\sum }_{i = 0}^{9} subm 1 ( i ) \\ = 1610\end{matrix}$$

$$\begin{matrix}subm 2 = {\sum }_{i = 0}^{9} subm 2 ( i ) \\ = 1470\end{matrix}$$

With respect to the sub-scanning direction, the G image data illustrated in FIG. 14(b) is subjected to a process similar to the process for the main scanning direction, thereby to calculate out that subs1 is 1520 and subs2 is 1950.

The obtained subm1, subm2, subs1, subs2 satisfy|subm1−subm2|≦|subs1−subs2| when applied to Equation 1. From this, it is found that busy=3470 and busy_sub=430. When the busy and busy_sub obtained are applied to Equation 2 using the predetermined THpair (=0.3), the following is obtained:
busy_sub/busy=0.12

As understood from the above, Equation 2 is satisfied. Accordingly, the flat halftone discrimination signal flat of 1, which indicates that the segment block is in flat halftone, is outputted.

For the G image data illustrated in FIG. 14(b), the threshold value setting section 42 sets the average density (=139) as the threshold value th1.

FIG. 14(c) illustrates binary data obtained via the binarization process of the G image data illustrated in FIG. 14(b), the binarization process being performed by the binarization section 43 using the threshold value th1 (=139) that is set by the threshold value setting section 42. As illustrated in FIG. 14(c), the use of the threshold value th1 allows extracting only the magenta dots, on which the calculation of the transition numbers is based.

With respect to FIG. 14(c), the maximum transition number calculating section 44 calculates out the maximum transition number m rev (=8) of the segment block in the following manner.

(1) Calculate out transition number revm(j) (where j=0 to 9) for each line in the main scanning direction, the transition number revm(j) indicating how many times the binary data is switched over in a given line in the main scanning direction.

(2) Calculate out (find out) the maximum m revm among the revm (j).

(3) Calculate out transition number revs(i) (where i=0 to 9) for each line in the sub scanning direction, the transition number revs(i) indicating how many times the binary data is switched over in a given line in the sub scanning direction.

(4) Calculate out (find out) the maximum m revs among the revs (i).

(5) Calculate out the maximum transition number m rev in the segment block from the following equation:
m rev=m revm+m revs.

Other examples of how to calculate the maximum transition number m rev of the segment block encompass use of either of the following equations:
m rev=m revm×m revs
m rev=max(m revm, m revs)

The transition number in the segment block is uniquely dependent on resolution at which the capturing apparatus such as a scanner captures the image, and the halftone frequency on the printed matter. For example, in the case of the halftone illustrated in FIG. 14(a), 4 dots are present in the segment block. Thus, the maximum transition number m rev in this segment block is theoretically in a range of 6 to 8.

The segment block data illustrated in FIG. 14(b) represents a flat halftone portion (a halftone region in which the density transition is low), which satisfies Equation 2, as described above. Therefore, the calculated maximum transition number m rev (=8) is within the theoretical maximum transition number ranging from 6 to 8.

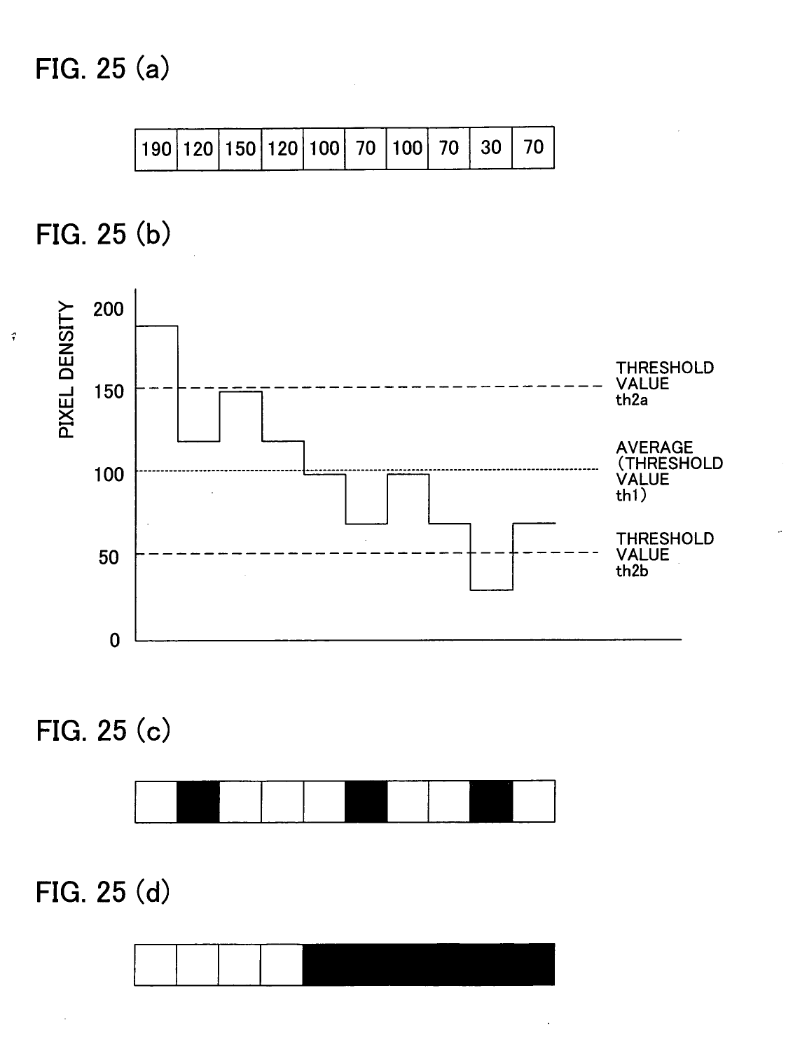

On the other hand, for a segment block of the non-flat halftone portion (e.g., see FIG. 25(a)) in which the density transition is high, the threshold value setting section 42 sets only one threshold value. Thus, if the segment block was of the non-flat halftone portion, the transition number calculated would be much smaller than the transition number that is supposed to be calculated out. For example, even if th1, th2a, th2b illustrated in FIG. 25(b) were set as threshold values, the transition number calculated would be much smaller than the transition number that is supposed to be calculated out. Specifically, as illustrated in FIG. 25(c) in which binary data correctly reproducing the halftone frequency is illustrated, the transition number that is supposed to be calculated out is 6. However, in FIG. 25(d) in which the binary data obtained from FIG. 25(a) using the threshold value th1, the transition number is 2. Therefore, the calculated transition number is much smaller than the transition number that is supposed to be calculated out. This would deteriorate the halftone frequency determination accuracy.

However, the halftone frequency determining section 14 of the present embodiment calculates out the maximum transition number average only in the segment block in the flat halftone region for which the halftone frequency can be correctly reproduced by using only one threshold value for the segment block. Thus, according to the halftone frequency determining section 14 of the present embodiment, it is possible to improve the halftone frequency determination accuracy.

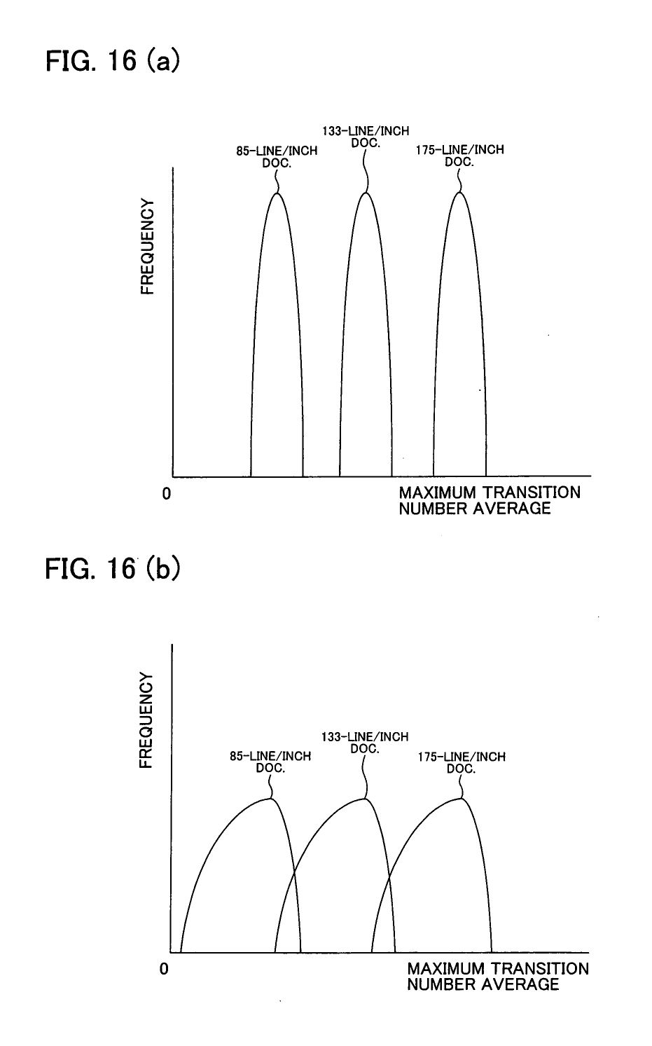

FIG. 16(b) gives an example of frequency distributions of maximum transition number averages of 85-frequency halftone documents, 133-frequency halftone documents, and 175-frequency halftone documents. In the example illustrated in FIG. 16(b), not only the flat halftone region in which the density transition is low, but also the non-flat halftone region in which the density transition is high is used. The binarization process of a halftone region in which the density transition is high cannot extract the black pixel portions (that indicate the halftone portions) as illustrated in FIG. 25(c) but discriminates the white pixel portion (that indicates a low density halftone portion) and the black pixel portion (that indicates a high density halftone portion) as illustrated in FIG. 25(d). As a result, the calculated transition number is too small for the halftone frequency that correctly represents the halftone in question. This increases a number of the input images in which the maximum transition number average is smaller than in the case where the calculation is done with respect to only the flat halftone region, thereby extending the distribution of the maximum transition number averages of halftones of each halftone frequency in the smaller direction. Consequently, the frequency distributions overlap each other, whereby the halftone frequencies in portions of the document which correspond to the overlapping cannot be determined accurately.

However, the halftone frequency determining section 14 of the present embodiment calculates out the maximum transition number average of only the segment blocks that are in the flat halftone regions in which the density transition is low. FIG. 16(a) gives an example of frequency distributions of maximum transition number averages of 85-frequency halftone documents, 133-frequency halftone documents, and 175-frequency halftone documents. In the example illustrated in FIG. 16(a), only the flat halftone region in which the density transition is low is used. By using the flat halftone region in which the density transition is low, it is possible to generate binary data that reproduces the halftone frequency accurately. Thus, halftone frequencies have different maximum transition number averages, thereby eliminating, or reducing, the overlapping of the frequency distributions of the halftone frequencies. This makes it possible to attain higher halftone frequency determination accuracy.

As described above, the image processing apparatus 2 according to the present embodiment is provided with the halftone frequency determining section 14 for determining the halftone frequency of the input image. The halftone frequency determining section 14 is provided with the flat halftone discriminating section 41, the extracting means (threshold value setting section 42, binarization section 43, maximum transition number calculating section 44, and maximum transition number averaging section 45), and the halftone frequency estimating section 46. The flat halftone discriminating section 41 extracts the information of density distribution per segment block consisting of a plurality of pixels, and discriminates, based on the information of density distribution, whether a given segment block is a flat halftone region (in which the density transition is low) or a non-flat halftone region (in which the density transition is high). The extraction means extracts the maximum transition number average of the segment block discriminated as a flat halftone region by the flat halftone discriminating section 41. The maximum transition number average is used as the feature of the segment block that indicates the extent of the density transition between pixels. (An example of such a feature is a feature of the density transition between pixels of the segment block.) The halftone frequency estimating section 46 estimates the halftone frequency from the maximum transition number average extracted by the extraction means.

With this, the halftone frequency is determined based on the maximum transition number average of the segment block included in the flat halftone region in which the density transition is low (the maximum transition number average is a feature of density transition between pixels of the segment block). Specifically, the halftone frequency is determined after the influence from the non-flat halftone region in which the density transition is high and which causes the determination of the halftone frequency to be different from the halftone frequency that correctly represents the halftone in question is removed. This makes it possible to determine the halftone frequency accurately.

Moreover, the binarization with respect to the non-flat halftone region in which the density transition is high results in unfavorable discrimination of the white pixel portion (low density halftone portion) and black pixel portion (high density halftone portion) as illustrated in FIG. 25(d). Such binarization does not generate the binary data that extracts only the printed portion of the halftone thereby correctly reproducing the halftone frequency, as illustrated in FIG. 25(c).

However, in the present embodiment, the maximum transition number averaging section 45 extracts, as the feature indicting an extent of the density transition, the average of only the transition numbers of the segment blocks that are discriminated as the flat halftone regions by the flat halftone discriminating section 41, from among the transition numbers calculated by the maximum transition number calculating section 44. Specifically, the maximum transition number average extracted as the feature corresponds to the flat halftone region in which the density transition is low and from which the binary data correctly reproducing the halftone frequency can be generated. Therefore, the use of the maximum transition number average makes it possible to determine the halftone frequency accurately.

<Example of Process Using Halftone Frequency Determination Signal>

An example of the process based on the result of the halftone frequency discrimination performed by the halftone frequency determining section 14 is described below.

In halftone images, moiré sometimes occurs due to interference between the halftone frequency and a periodic intermediate tone process (such as dither process). To prevent moiré, a smoothing process that reduces amplitude of the halftone image in advance may be adopted. Such a smoothing process may be sometimes accompanied with such image deterioration that a halftone photo and a character on halftone are blurred. Examples of solutions for this problem are as follows:

(1) Employ smoothing/enhancing mixing filter that reduces an amplitude of only the moiré-causing frequency of the halftone while amplifying an amplitude of a frequency component lower than the frequency of a constituent element (human, landscape, etc.) of the photo or of a character.

(2) Detect a character located on a halftone and subject such a character to an enhancing process, which is not carried out for the photo halftone and background halftone.

Here, (1) is discussed. Different halftone frequencies require the filter to have different frequency properties in order to prevent the moiré and keep the sharpness of the character on halftone and the halftone photo at the same time. Therefore, according to the halftone frequency determined by the halftone frequency determining section 14, the spatial filter processing section 18 performs a filtering process having the frequency property suitable for the halftone frequency. With this, it is possible to attain the moiré prevention and sharpness of the halftone photo and character on halftone at the same time for halftones of any frequencies.

On the other hand, if, as in the conventional art, the frequency of the halftone image was unknown, it would be necessary to have a process that prevents moiré in the halftone images of all the frequencies, in order to prevent moiré that causes the most significant image deterioration. This does not allow using any smoothing filters except a smoothing filter that reduces the amplitudes of all the halftone frequencies. The use of such a smoothing filter results in blurring of the halftone photo and the character on halftone.

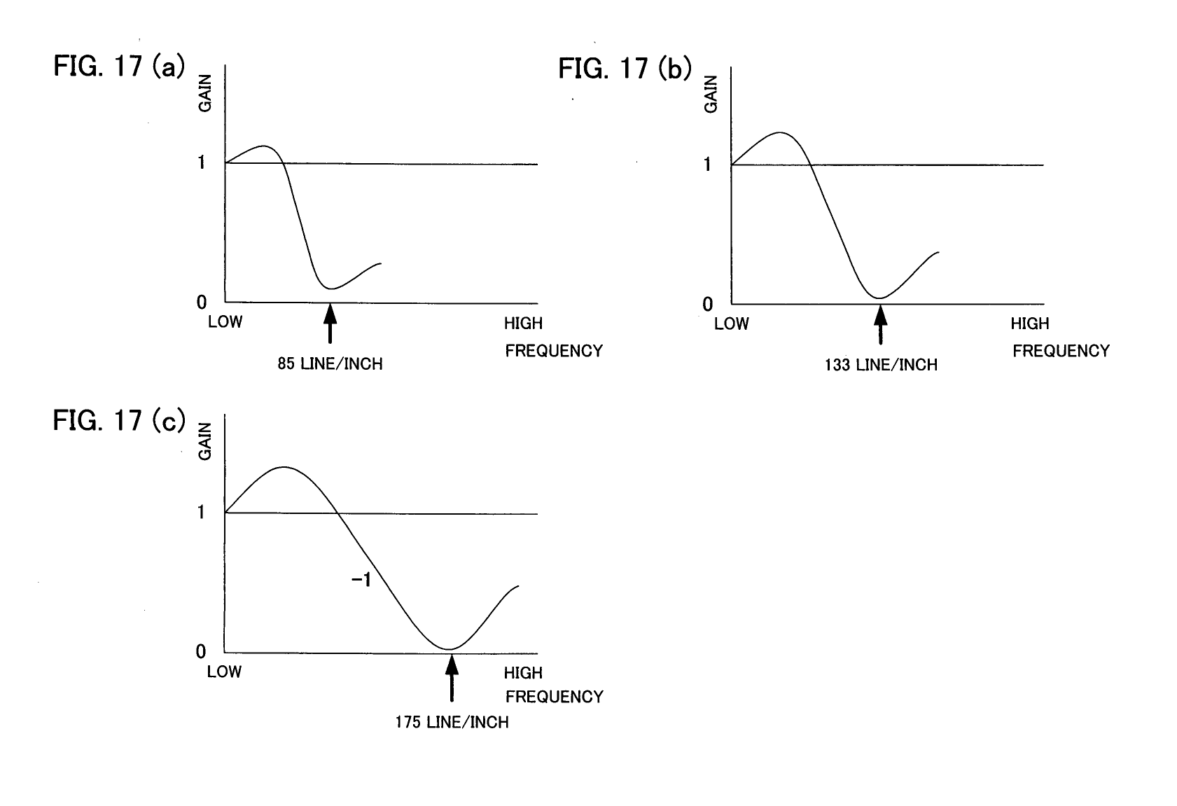

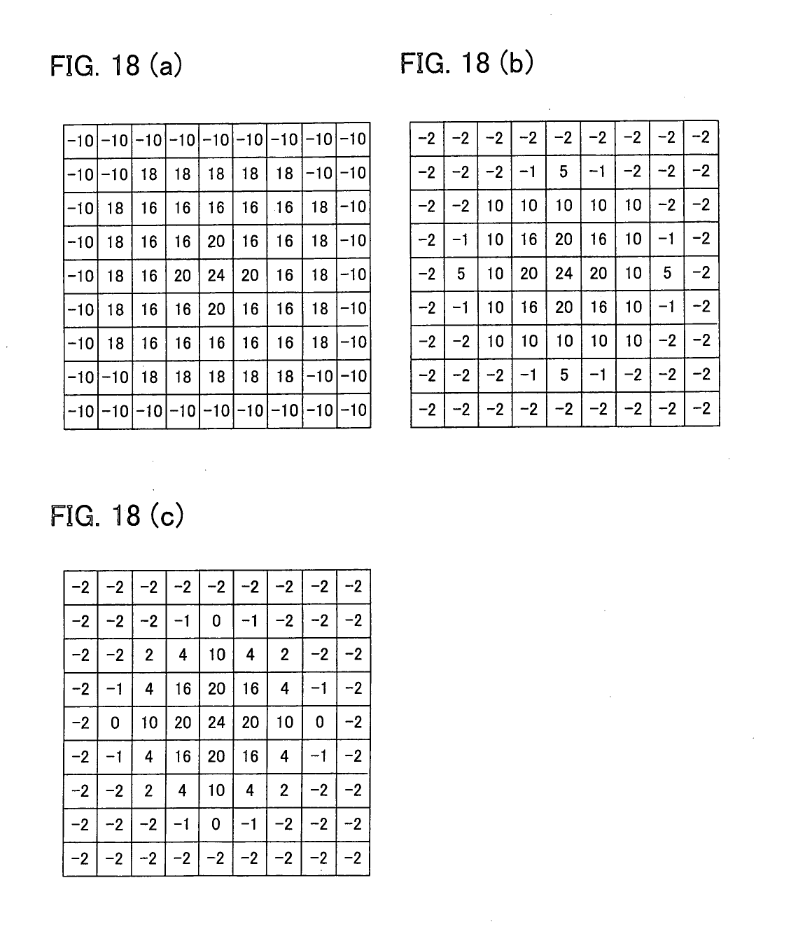

FIG. 17(a) gives an example of a filter frequency property most suitable for the 85-frequency halftone. FIG. 17(b) gives an example of a filter frequency property most suitable for the 133-frequency halftone. FIG. 17(c) gives an example of a filter frequency property most suitable for the 175-frequency halftone. FIG. 18(a) gives an example of filter coefficients corresponding to FIG. 17(a). FIG. 18(b) gives an example of filter coefficients corresponding to FIG. 17(b). FIG. 18(c) gives an example of filter coefficients corresponding to FIG. 17(c).

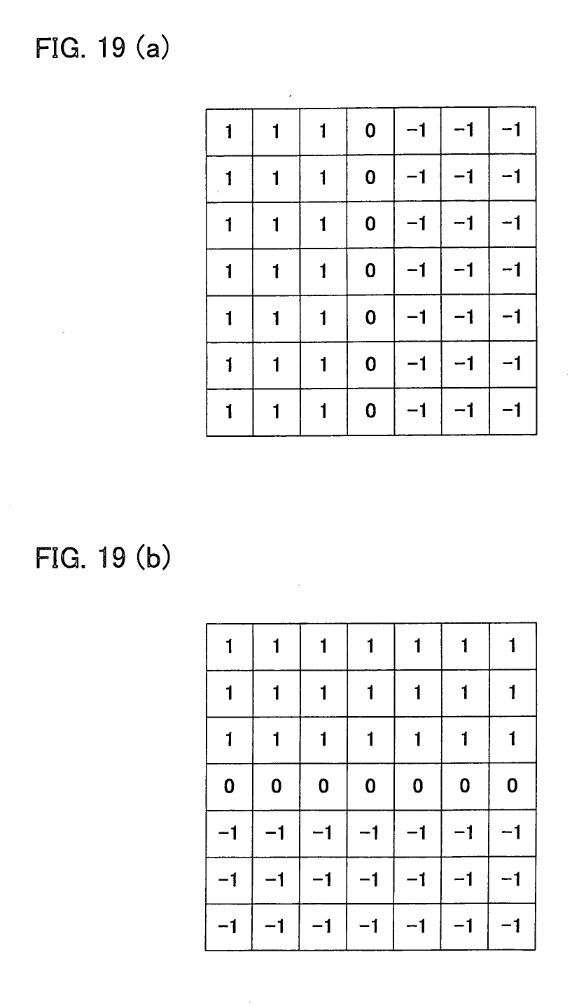

Here, (2) is discussed. Use of a low-frequency edge detecting filter or the like, as illustrated in FIG. 19(a) or 19(b), can detect the character on high-frequency halftone highly accurately without erroneously detecting the edge of the high-frequency halftone, because the character and the high-frequency halftone are different in the frequency properties. However, for the low-frequency edge detecting filter or the like, it is difficult to detect a character on low-frequency halftone because the low-frequency halftone has a frequency property similar to that of the character. If such a character on low-frequency halftone was detected, erroneous detection of the halftone edge would be significant, thereby causing poor image quality. Hence, based on the frequency of the halftone image determined by the halftone frequency determining section 14, a detection process for the character on halftone is carried out by the segmentation process section 21 only when the character is on a high-frequency halftone, e.g. 133-frequency halftone or higher. Alternatively, a result of the halftone edge would be valid only when the character is on a high-frequency halftone, e.g., 133-frequency halftone or higher. With this, it is possible to improve readability of the character on high-frequency halftone without causing the image deterioration.

The process using the halftone frequency determination signal may be carried out by the color correction section 16 or the tone reproduction process section 20.

<Modification 1>

In the above embodiment, the flat halftone determining process and threshold value setting/binarization/maximum transition number calculation are performed in parallel, and the average of the transition numbers in the halftone region is calculated out only from the transition numbers of the segment blocks from which the flat halftone discrimination signal flat of 1 is outputted. In this case, to speed up the parallel processes, it is necessary to provide at least two CPUs respectively for the flat halftone determination and for the threshold value setting/binarization/maximum transition number calculation.

In case where only one CPU is provided for performing each process, it may be arranged such that the flat halftone discriminating process is carried out first so that the threshold value setting/binarization/maximum transition number calculation is carried out for the halftone region which is discriminated as a flat halftone portion.

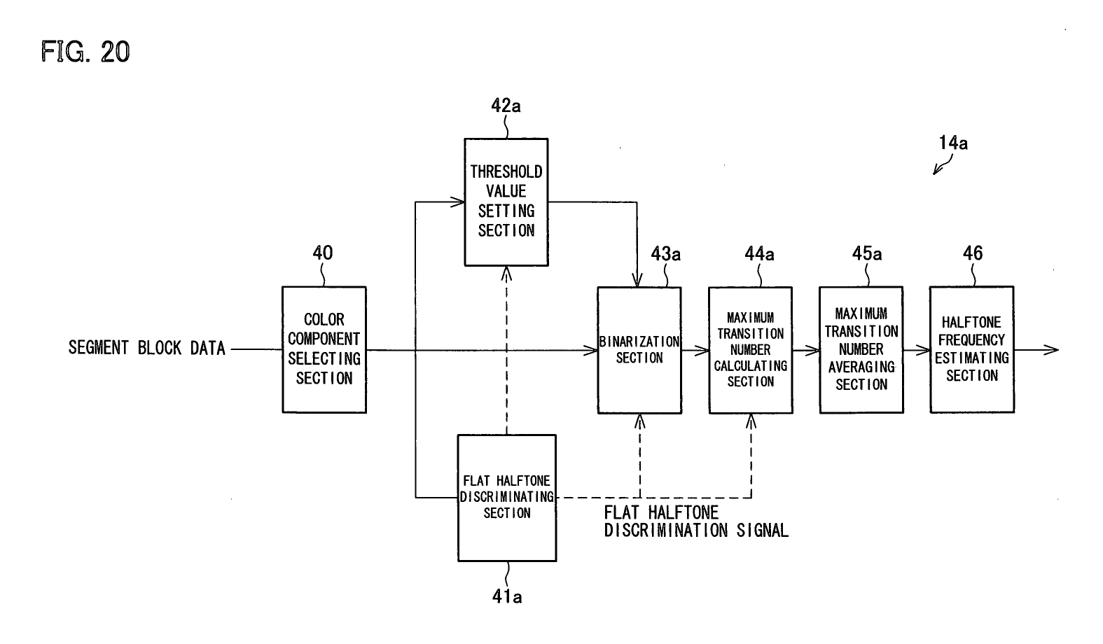

In this arrangement, the halftone frequency determining section 14 as illustrated in FIG. 1 is replaced with a halftone frequency determining section (halftone frequency determining means) 14a as illustrated in FIG. 20.

The halftone frequency determining section 14a is provided with a color component selecting section 40, a flat halftone discriminating section (flat halftone discriminating section means) 41a, a threshold value setting section (extraction means, threshold value setting means) 42a, a binarization section (extraction means, binarization means) 43a, a maximum transition number calculating section (extraction means, transition number calculating means) 44a, a maximum transition number averaging section (extraction means, transition number calculating means) 45a, and a halftone frequency estimating section 46.

The flat halftone discriminating section 41a performs a flat halftone discriminating process similar to that of the flat halftone discriminating section 41, and outputs a flat halftone discrimination signal flat, which indicates a result of the discrimination, to the threshold value setting section 42a, the binarization section 43a, and the maximum transition number calculating section 44a. Only for the segment blocks for which the flat halftone determination signal of 1 is outputted, the threshold value setting section 42a, the binarization section 43a, and the maximum transition number calculating section 44a respectively perform threshold value setting, binarization, and maximum transition number calculation similar to those corresponding processes performed by the threshold value setting section 42, the binarization section 43, and the maximum transition number calculating section 44.

The maximum transition number averaging section 45a calculates an average of all the maximum transition numbers calculated by the maximum transition number calculating section 44.

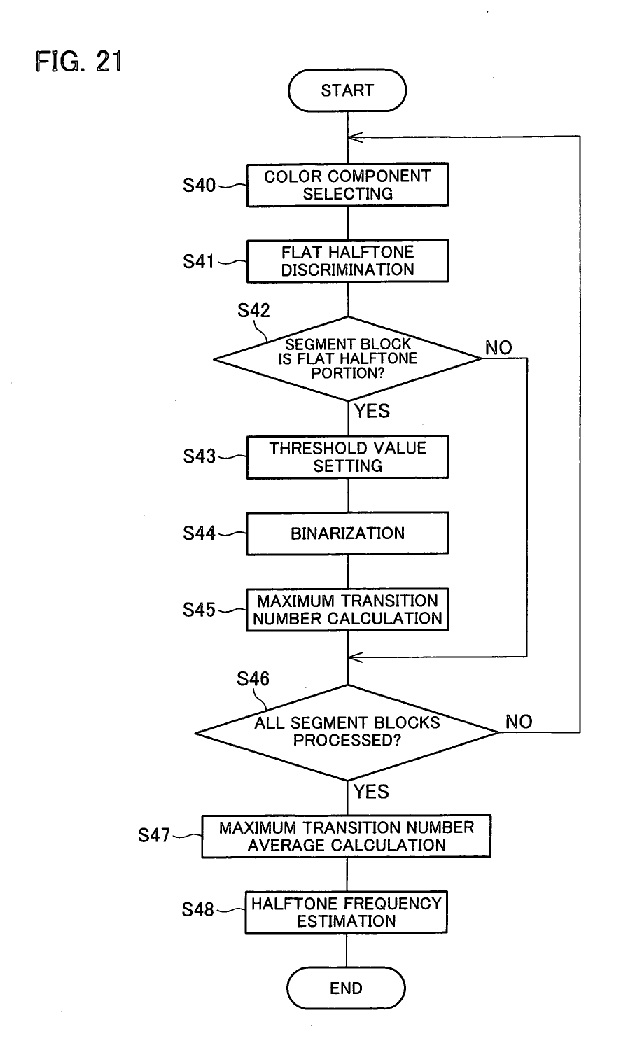

FIG. 21 is a flowchart illustrating a method of the halftone frequency determining process performed by the halftone frequency determining section 14a.

Firstly, the color component selecting section 40 performs the color component selecting process for selecting a color component having a busyness higher than the rest color components (S40). Next, the flat halftone frequency discriminating section 41a performs the flat halftone frequency discriminating process and outputs the flat halftone frequency discrimination signal flat (S41).

Next, the threshold value setting section 42a, the binarization section 43a, and the maximum transition number calculating section 44a judges whether the flat halftone discrimination signal flat is “1” indicating that the segment block is of the flat halftone portion, or “0” indicating that the segment block is of the non-flat halftone portion. That is, whether the segment block is of the flat halftone portion or not is judged (S42).

For the segment block of the flat halftone portion, that is, for the segment block for which the flat halftone discrimination signal flat=1, the threshold value setting section 42a performs the threshold value setting (S43), the binarization section 43a performs the binarization (S44), and the maximum transition number calculating section 44a performs the maximum transition number calculation (S45) in this order, followed by S46.

On the other hand, for the segment block of the non-flat halftone portion, that is, for the segment block for which the flat halftone discrimination signal flat=0, the process goes to S46 with the threshold value setting section 42a, the binarization section 43a, the maximum transition number calculating section 44a performing nothing.

Next, at S46, it is judged whether or not the processes are done for all the segment blocks. If not, the processes of the S40 to S45 are repeated for the next segment block.

If yes, the maximum transition number averaging section 45a calculates out an average of the maximum transition numbers, calculated at S45, of the whole halftone region (S47). Note that the maximum transition numbers of the segment blocks for which the flat halftone discrimination signal flat=1 are calculated out at S45. Therefore, the average of the maximum transition numbers of the segment blocks of the flat halftone portion is calculated out at S47. Then, the halftone frequency estimating section 46 estimates the halftone frequency of the halftone region from the average calculated out by the maximum transition number averaging section 45a (S48). By this the halftone frequency determining process is completed.

As described above, the threshold value setting section 42a, binarization section 43a, and maximum transition number calculating section 44a are only required to perform the threshold value setting, binarization, and maximum transition number calculation respectively with respect to only the segment blocks judged as the flat halftone portion(s). Thus, the halftone frequency determining process may be improved by using only one CPU.

Moreover, the maximum transition number averaging section 45a calculates out the average of the maximum transition numbers of the segment blocks judged as the flat halftone portion(s). That is, the calculated-out maximum transition number average reflects the flat halftone portion(s) in which the density transition is low and from which the binary data correctly reproducing the halftone frequency can be generated. With this, the halftone frequency can be determined highly accurately by determining the halftone frequency by using the maximum transition number average.

<Modification 2>

The halftone frequency determining section 14 may be replaced with a halftone frequency determining section (halftone frequency determining means) 14b. The halftone frequency determining section 14b is provided with a threshold value setting section (extraction means, threshold value setting means) 42b, instead of the threshold value setting section 42. While the threshold value setting section 42 sets the average density of the pixels of the segment blocks as the threshold value, the threshold value setting section 42b sets a fixed value as the threshold value.

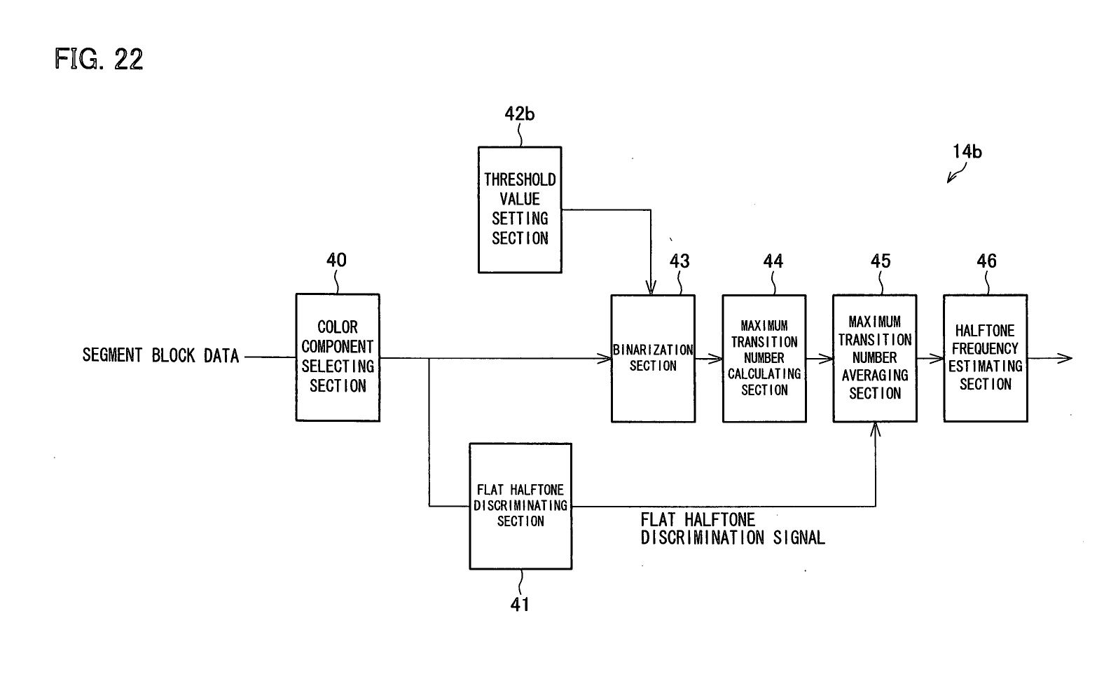

FIG. 22 is a block diagram illustrating an arrangement of the halftone frequency determining section 14b. As illustrated in FIG. 22, the halftone frequency determining section 14b is identical with the halftone frequency determining section 14, expect that the halftone frequency determining section 14b is provided with the threshold value setting section 42b instead of the threshold value setting section 42.

The threshold value setting section 42b sets a predetermined fixed value as the threshold value for use in binarization of segment block. For example, the fixed value may be 128, which is a median of the whole density range (from 0 to 255).

With this arrangement using the threshold value setting section 42b, it is possible to dramatically shorten the processing time of the threshold value setting.

<Modification 3>

In the arrangement described above, the flat halftone discriminating process is performed by the flat halftone discriminating section 41, based on the difference in density between the adjacent pixels. However, the flat halftone discriminating process is not limited to this arrangement. For example, flat halftone discriminating process of the G image data illustrated in FIG. 14(b) may be performed by the flat halftone discriminating section 41 in the following manner.

To begin with, average densities Ave_sub 1 to 4 of pixels of sub segment blocks 1 to 4, which are tetrametric of the segment block illustrated in FIG. 15, are obtained from the following Equations:

$$Ave\_sub1 = {\sum }_{i = 0}^{4} {\sum }_{j = 0}^{4} f ( i , j ) / 25$$

$$Ave\_sub2 = {\sum }_{i = 0}^{4} {\sum }_{j = 5}^{9} f ( i , j ) / 25$$

$$Ave\_sub3 = {\sum }_{i = 5}^{9} {\sum }_{j = 0}^{4} f ( i , j ) / 25$$

$$Ave\_sub3 = {\sum }_{i = 5}^{9} {\sum }_{j = 5}^{9} f ( i , j ) / 25$$

In the following conditional equation using the Ave_sub 1 to 4 is satisfied, a flat halftone discrimination signal of 1, which indicates the segment block is of flat halftone, is outputted. If not, a flat halftone discrimination signal of 0, which indicates the segment block is of non-flat halftone, is outputted. The conditional equation is as follows:
max (|Ave_sub 1−Ave_sub 2, Ave_sub 1−Ave_sub 3|, Ave_sub 1−Ave_sub 4|, |Ave_sub 2−Ave_sub 3|, Ave_sub 2−Ave_sub 4|, |Ave_sub 3−Ave_sub 4|).

TH_avesub is a threshold value predetermined via experiment.

For example, for the segment block illustrated in FIG. 14(b), Ave_sub 1=136, Ave_sub 2=139, Ave_sub 3=143, Ave_sub 4=140.

Then, max (Ave_sub 1−Ave_sub 2|, |Ave_sub 1−Ave_sub 3|, |Ave_sub 1−Ave_sub 4|, |Ave_sub 2−Ave_sub 3|, |Ave_sub 2−Ave_sub 4|, |Ave_sub 3−Ave_sub 4|)=7. This value is compared with TH_avesub. The flat halftone discrimination signal is outputted based on the comparison.

As described above, in Modification 3, the segment block is partitioned into plural sub segment blocks and the average densities of pixels in respective sub segment blocks are obtained. Then, the judgment on whether the segment block is of the flat halftone portion or of non-flat halftone portion is made based on the maximum value among the differences between the average densities of the sub segment blocks.

With this modification, it is possible to shorten the time period necessary for the arithmetic process, compared with the arrangement described above in which the judgment using the absolute difference sums subm and subs between adjacent pixels is employed.

### Second Embodiment

Another embodiment according to the present invention is described below. Sections having the like functions as the corresponding sections in the first embodiment are labeled with like references and their explanation is omitted here.

The present embodiment relates to an image reading process apparatus provided with a halftone frequency determining section 14 of the first embodiment.

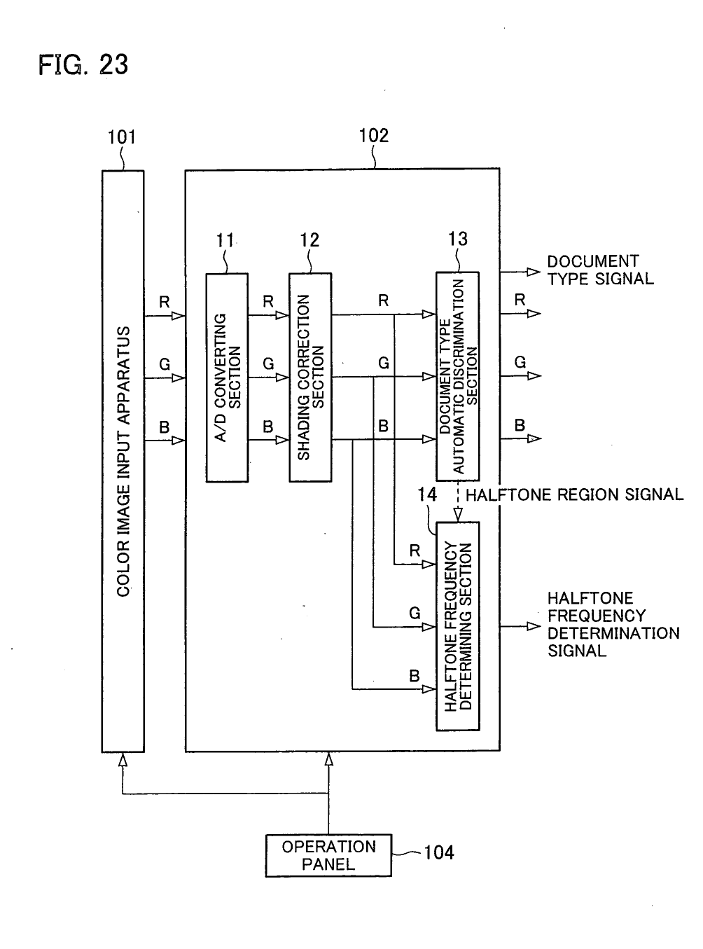

The image reading process apparatus according to the present embodiment is, as illustrated in FIG. 23, with a color image input apparatus 101, an image processing apparatus 102, and an operation panel 104.

The operation panel 104 is provided with a setting key(s) for setting operation modes of the image reading process apparatus, ten keys, a liquid crystal display apparatus, and/or the like.

The color image input apparatus 101 is provided with a scanner section, for example. The color image input apparatus 101 reads reflection image from a document via a CCD (Charge Coupled Device) as RGB analog signals (R: red; G: green; and B: blue).

The image processing apparatus 102 is provided with an A/D (analog/digital) converting section 11, a shading correction section 12, a document type automatic discrimination section 13, and a halftone frequency determining section 14, which have been described above.

The document type automatic discrimination section 13 in the present embodiment outputs a document type signal to an apparatus (e.g. a computer, printer or the like) in downstream thereof, the document type signal indicating which type a document is. Moreover, the halftone frequency determining section 14 of the present embodiment outputs a halftone frequency determination signal to an apparatus (e.g. a computer, printer or the like) in downstream thereof, the halftone frequency determination signal indicating halftone frequency determined by the halftone frequency determining section 14.

As described above, the image reading process apparatus outputs the document type signal and the halftone frequency determination signal to the computer in the downstream thereof, in addition to RGB signals representing the document. Alternatively, the image reading process apparatus may be arranged to output these signals to the printer directly, without a computer interposed therebetween. Again in this arrangement, the document type automatic discrimination section 13 is not inevitably necessary. Moreover, the image processing apparatus 102 may be provided with the halftone frequency determining section 14a or the halftone frequency determining section 14b, in lieu of the halftone frequency determining section 14.

The present invention is not limited to color image data, even though the first and second embodiments are arranged such that the image processing apparatus 2 and 102 receives the color image data. That is, the image processing apparatuses 2 and 102 may receive monochrome data. Halftone frequency of monochrome data can be highly accurately judged by extracting transition numbers (which a feature representing the density) of only segment blocks of flat halftone portion(s) in which the density transition is low. If the received data is monochrome data, the halftone frequency determining section 14, 14a, or 14b of the image processing apparatus 2 or 102 may not be provided with the color component selecting section 40.

Moreover, the present invention is not limited to the rectangular shape of the segment blocks, even though the above description discusses such segment blocks. The segment block may have any shape in the present invention.

[Description on Program and Storage Medium]

Moreover, the halftone frequency determining process according to the present invention may be realized as software (application program). With this arrangement, it is possible to provide a computer or printer with a printer drive in which the software realizing a process that is performed based on the halftone frequency determination result is incorporated.

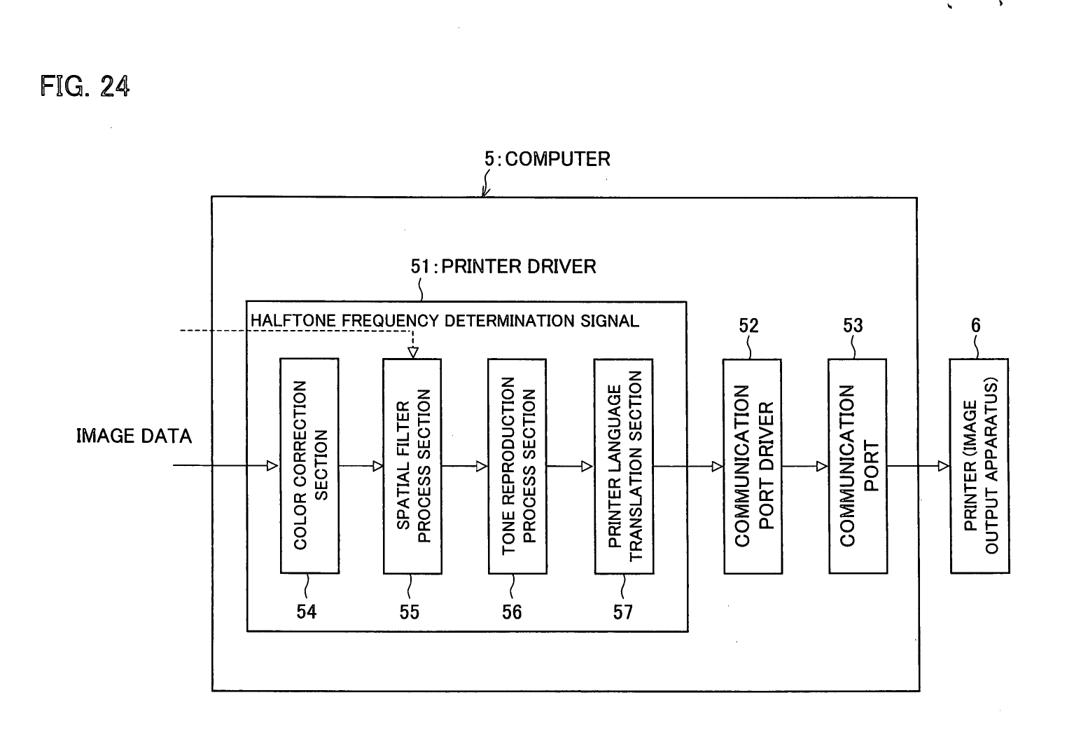

As an example of the above arrangement, a process that is performed based on the halftone frequency determination result is described below, referring to FIG. 24.

As illustrated in FIG. 24, a computer 5 is provided with a printer driver 51, a communication port driver 52, and a communication port 53. The printer driver 51 is provided with a color correction section 54, a spatial filter processing section 55, a tone reproduction process section 56, and a printer language translation section 57. Moreover, the computer 5 is connected with a printer (image outputting apparatus) 6. The printer 6 outputs an image according to image data outputted thereto from the computer 5.

The computer 5 is arranged such that the image data generated by execution of various application program(s) is subjected to color correction process performed by the color correction section 54 thereby to eliminate color impurity. Then, the image data is subjected to filtering process performed by the spatial filter process section 55. The filtering process is based on the halftone frequency determination result. In this arrangement, the color correction section 54 also performs black generating/background color removing process.

The image data subjected to the above processes is then subjected to a tone reproduction (intermediate tone generation) by the tone reproduction process section 56. After that, the image data is translated into a printer language by the printer language translation section 57. Then, the image data translated in the printer language is inputted into the printer 6 via the communication port driver 52, and the communication port (for example, RS232C, LAN, or the like) 53. The printer 6 may be a digital complex machine having a copying function and/or faxing function, in addition to the printing function.

Moreover, the present invention may be realized by recoding, in a computer-readable storage medium, a program for causing a computer to execute the image processing method in which the halftone frequency determining process is performed.

Thereby, a storage medium in which the program for performing the image processing method in which the halftone frequency is determined and suitable processes are performed based on the halftone frequency determined can be provided in a form that allows the storage medium to be portably carried around.

As long as the program is executable on a microcomputer, the storage medium may be (a) a memory (not illustrated), for example, a program medium such as ROM, or (b) a program medium that is readable on a program reading apparatus (not illustrated), which serves as an external recording apparatus.

In either arrangement, the program may be such a program that is executed by the microprocessor accessing to the program stored in the medium or such a program that is executed by the microprocessor executing the program read out and downloaded to a program recording area (not illustrated) of the microcomputer. In this case, the microcomputer is installed in advance with a program for downloading.

In addition, the program medium is a storage medium arranged so that it can be separated from the main body. Examples of such a program medium includes storage media that hold a program in a fixed manner, and encompasses: tapes, such as magnetic tapes, cassette tapes, and the like; magnetic disks, such as flexible disks, hard disk, and the like; discs, such as CD-ROM, MO, MD, DVD, and the like; card-type recording media, such as IC cards (inclusive of memory cards), optical cards and the like; and semiconductor memories, such as mask ROM, EPROM (erasable programmable read only memory), EEPROM (electrically erasable programmable read only memory), flash ROM and the like.

Alternatively, if a system can be constructed which can connect to the Internet or other communications network, the program medium may be a storage medium carrying the program in a flowing manner as in the downloading of a program over the communications network. Further, when the program is downloaded over a communications network in this manner, it is preferable if the program for download is stored in a main body apparatus in advance or installed from another storage medium.

The storage medium is arranged such that the image processing method is carried out by reading the recording medium by using a program reading apparatus provided to a digital color image forming apparatus or a computer system.

The computer system is provided with an image input apparatus (such as a flat head scanner, film scanner, digital camera, or the like), a computer for executing various processes inclusive of the image process method by loading thereon a certain program(s), an image display device (such as a CRT display apparatus, a liquid crystal display apparatus, or the like), and a printer for outputting, on paper or the like, process result of the computer. Further, the computer system is provided with communication means (such as a network card, modem, or the like) for being connected with a server or the like via the network.

As described above, an image processing apparatus according to the present invention is provided with halftone frequency determining means for determining a halftone frequency of an inputted image. The image processing apparatus according to the present invention is arranged such that the halftone frequency determining means includes flat halftone discriminating means for extracting information of density distribution per segment block consisting of a plurality of pixels, and discriminating, based on the information of density distribution, whether the segment block is a flat halftone region in which density transition is low or of a non-flat halftone region in which the density transition is high; extracting means for extracting a feature of density transition between pixels of the segment block which the flat halftone discriminating means discriminates as the flat halftone region; and halftone frequency estimating means for estimating the halftone frequency, based on the feature extracted by the extracting means.

Here, the segment block is not limited to a rectangular region and may have any kind of shape arbitrarily.

In this arrangement, the flat halftone discriminating means extracts information of density distribution per segment block consisting of a plurality of pixels, and discriminates, based on the information of density distribution, whether a given segment block is a flat halftone region (in which the density transition is low) or a non-flat halftone region (in which the density transition is high). Then, the extracting means extracts the feature of the density transition between the pixels of the segment block which the flat halftone discriminating means discriminates as the flat halftone region. The halftone frequency is determined based on the feature.

As described above, the halftone frequency is determined based on the feature of the density transition between pixels of the segment block which is included in the flat halftone region in which the density transition is low. That is, the determination of the halftone frequency is carried out after removing the influence of the non-flat halftone region in which the density transition is high and which causes erroneous halftone frequency determination. In this way, accurate halftone frequency determination is attained.

In addition to the above-mentioned arrangement, the image processing apparatus according to the present invention may be arranged such that the extracting means comprises: threshold value setting means for setting a threshold value for use in binarization for the segment block that the flat halftone discriminating means discriminates as the flat halftone region; binarization means for performing the binarization in order to generate binary data of each pixel in the segment block according to the threshold value set by the threshold value setting means; transition number calculating means for calculating out transition numbers of the binary data generated by the binarization means; and

transition number extracting means for extracting, as the feature, a transition number of that segment block which the flat halftone discriminating means discriminates as the flat halftone region, from among the transition numbers calculated out by the transition number calculating means.

As described above, the binarization with respect to the non-flat halftone region in which the density transition is high results in unfavorable discrimination of the white pixel portion (low density halftone portion) and black pixel portion (high density halftone portion) as illustrated in FIG. 25(d). Such binarization does not generate the binary data that extracts only the printed portion of the halftone thereby correctly reproducing the halftone frequency, as illustrated in FIG. 25(c).

However, even if the binarization using a single threshold value is used with respect to the segment blocks, the above arrangement allows discriminating the flat halftone region in which the density transition is low and from which the binary data from which the halftone frequency can be reproduced correctly can be generated. Then, the transition number extracting means extracts, as the feature, only the transition number of the segment block that is discriminated as the flat halftone region by the flat halftone discriminating means, from among the transition numbers calculated out by the transition number calculating means.

With this, the transition number extracted as the feature corresponds to the flat halftone region in which the density transition is low and from which the binary data correctly reproducing the halftone frequency can be generated. Therefore, the use of the transition number extracted as the feature makes it possible to determine the halftone frequency accurately.

In addition to the above-mentioned arrangement, the image processing apparatus according to the present invention may be arranged such that the extracting means comprises: threshold value setting means for setting a threshold value for use in binarization; binarization means for performing the binarization in order to generate, according to the threshold value set by the threshold value setting means, binarization data of each pixel in the segment block that the flat halftone discriminating means discriminates as the flat halftone region; and transition number calculating means for calculating out, as the feature, a transition number of the binary data generated by the binarization means.

In this arrangement, the binarization means generates the binary data of each pixel in the segment block that is discriminated as the flat halftone region by the flat halftone discriminating means. Then, the transition number calculating means calculates out, as the feature, the transition number of the binary data generated by the binarization means. Therefore, the transition number calculated as the feature corresponds to the flat halftone region in which the density transition is low and from which the binary data that reproduces the halftone correctly can be generated. Therefore, the use of the transition number calculated as the feature allows accurate halftone frequency determination.

Further, in addition to either arrangement, the image processing apparatus may be arranged such that the threshold value set by the threshold value setting means is an average density of the pixels in the segment block.

In a case where the threshold value employed in the binarization is a fixed value, the fixed value would be out of the density histogram of the segment block or close to a maximum value or minimum value of the density histogram, depending on a width of the density histogram. If the fixed value was out of the density histogram or close to the maximum value or minimum value of the density histogram, binary data obtained using the fixed value could not be binary data that correctly reproduces the halftone frequency.

On the other hand, with this arrangement, the threshold value set by the threshold value setting means is the average density of the pixels in the segment block. Thus, the set threshold value is located substantially in the middle of the density histogram of the segment block, regardless of how the density histogram is. With this, the binary data that correctly reproduces the halftone frequency can be obtained by the binarization means regardless of how the density histogram is.

In addition to the above-mentioned arrangement, the image processing apparatus according to the present invention may be arranged such that the flat halftone discriminating means performs the discrimination whether the segment block is the flat halftone region or not based on density differences between adjacent pixels in the segment block.

With this arrangement, the use of the density differences between the adjacent pixels allows more accurate determination as to whether the segment block is of the flat halftone region or not.

In addition to the above-mentioned arrangement, the image processing apparatus according to the present invention may be arranged such that the segment block is partitioned into a predetermined number of sub segment blocks; and the flat halftone discriminating means finds average densities of pixels in the sub segment blocks, and performs the discrimination whether the segment block is the flat halftone region or not based on a difference(s) between the average densities of the sub segment blocks.

With this arrangement, the flat halftone discriminating means uses the difference(s) in the average densities between the sub blocks in determining the flat halftone region. Therefore, the processing time of the flat halftone discriminating means can be shorter compared with the arrangement in which the difference between the pixels is used.

An image forming apparatus may be provided with the image processing device of any of these arrangements.

By employing an image process in which the halftone frequency of the input image data is considered, e.g., by employing a filter process most suitable for the halftone frequency, this arrangement suppresses the moiré while avoiding deterioration of the sharpness and out-of-focusing as much as possible. Moreover, by detecting a character on halftone only in the halftone regions of 133 line/inch or higher and performing a most suitable process for such a character on halftone, it is possible to suppress the image quality deterioration by erroneous determination which is frequently caused for the halftones of halftone frequencies less than 133 line/inch. With this, it is possible to provide an image forming apparatus that outputs an image of good quality.

An image reading process apparatus may be provided with the image processing device of any of these arrangements.

With this arrangement, it becomes possible to output a halftone frequency determination signal based on accurate halftone frequency determination with respect to the halftone region included in the document.

By using an image process program for causing a computer to serve as each means of the image processing device of any of these arrangement, it is possible to easily realize the each means by using a general-purpose computer.

Moreover, the image processing program is preferably stored in a computer-readable storage medium.

With this arrangement, it is possible to easily realize the image processing apparatus on the computer by using the image processing program read out from the storage medium.

Moreover, an image processing method according to the present invention is applicable to either of color and monochrome digital copying machines. In addition, the image processing method is also applicable to any apparatus that is required to reproduce the inputted image data with higher reproduction quality. An example of such an apparatus is a reading apparatus such as scanners.

The invention being described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An image processing apparatus comprising:
halftone frequency determining means for determining a halftone frequency of an inputted image, the halftone frequency determining means comprising:
flat halftone discriminating means for extracting information of density distribution per segment block consisting of a plurality of pixels, and discriminating, based on the information of density distribution, whether the segment block is a flat halftone region in which density transition is low or of a non-flat halftone region in which the density transition is high;
extracting means for extracting a feature of density transition between pixels of the segment block which the flat halftone discriminating means discriminates as the flat halftone region; and
halftone frequency estimating means for estimating the halftone frequency, based on the feature extracted by the extracting means.

2. An image processing apparatus as set forth in claim 1, wherein:
the extracting means comprises:
threshold value setting means for setting a threshold value for use in binarization;
binarization means for performing the binarization in order to generate binary data of each pixel in the segment block according to the threshold value set by the threshold value setting means;
transition number calculating means for calculating out transition numbers of the binary data generated by the binarization means; and
transition number extracting means for extracting, as the feature, a transition number of that segment block which the flat halftone discriminating means discriminates as the flat halftone region, from among the transition numbers calculated out by the transition number calculating means.

3. An image processing apparatus as set forth in claim 1, wherein:
the extracting means comprises:
threshold value setting means for setting a threshold value for use in binarization;
binarization means for performing the binarization in order to generate, according to the threshold value set by the threshold value setting means, binarization data of each pixel in the segment block that the flat halftone discriminating means discriminates as the flat halftone region; and
transition number calculating means for calculating out, as the feature, a transition number of the binary data generated by the binarization means.

4. An image processing apparatus as set forth in claim 2, wherein:
the threshold value set by the threshold value setting means is an average density of the pixels in the segment block.

5. An image processing apparatus as set forth in claim 3, wherein:
the threshold value set by the threshold value setting means is an average density of the pixels in the segment block.

6. An image processing apparatus as set forth in claim 1, wherein:
the flat halftone discriminating means performs the discrimination whether the segment block is the flat halftone region or not based on density differences between adjacent pixels in the segment block.

7. An image processing apparatus as set forth in claim 1, wherein:
the segment block is partitioned into a predetermined number of sub segment blocks; and
the flat halftone discriminating means finds average densities of pixels in the sub segment blocks, and performs the discrimination whether the segment block is the flat halftone region or not based on a difference(s) between the average densities of the sub segment blocks.

8. An image forming apparatus comprising:
an image processing apparatus comprising:
halftone frequency determining means for determining a halftone frequency of an inputted image,
the halftone frequency determining means comprising:
flat halftone discriminating means for extracting information of density distribution per segment block consisting of a plurality of pixels, and discriminating, based on the information of density distribution, whether the segment block is a flat halftone region in which density transition is low or of a non-flat halftone region in which the density transition is high;
extracting means for extracting a feature of density transition between pixels of the segment block which the flat halftone discriminating means discriminates as the flat halftone region; and
halftone frequency estimating means for estimating the halftone frequency, based on the feature extracted by the extracting means.

9. An image reading process apparatus comprising:
an image processing apparatus comprising:
halftone frequency determining means for determining a halftone frequency of an inputted image,
the halftone frequency determining means comprising:
flat halftone discriminating means for extracting information of density distribution per segment block consisting of a plurality of pixels, and discriminating, based on the information of density distribution, whether the segment block is a flat halftone region in which density transition is low or of a non-flat halftone region in which the density transition is high; and
extracting means for extracting a feature of density transition between pixels of the segment block which the flat halftone discriminating means discriminates as the flat halftone region; and
halftone frequency estimating means for estimating the halftone frequency, based on the feature extracted by the extracting means.

10. An image processing method comprising:
determining a halftone frequency of an inputted image,
the step of determining the halftone frequency comprising:
discriminating a flat halftone, the step of discriminating including (a) extracting information of density distribution per segment block consisting of a plurality of pixels, and (b) discriminating, based on the information of density distribution, whether the segment block is a flat halftone region in which density transition is low or of a non-flat halftone region in which the density transition is high; and
extracting a feature of density transition between pixels of the segment block which is discriminated as the flat halftone region; and
estimating the halftone frequency, based on the feature extracted.

11. An image processing method as set forth in claim 10, wherein:
the step of extracting comprising:
setting a threshold value for use in binarization;
performing the binarization in order to generate binary data of each pixel in the segment block according to the set threshold value;
calculating out transition numbers of the binary data; and
extracting, as the feature, a transition number of that segment block which the step of discriminating discriminates as the flat halftone region, from among the transition numbers calculated out.

12. An image processing method as set forth in claim 10, wherein:
the step of extracting comprising:
setting a threshold value for use in binarization for the segment block that the step of discriminating discriminates as the flat halftone region;
performing the binarization in order to generate, according to the set threshold value, binarization data of each pixel in the segment block that the step of discriminating discriminates as the flat halftone region; and
calculating out, as the feature, a transition number of the binary data.

13. An image processing method as set forth in claim 11, wherein:
the threshold value set in the step of setting is an average density of the pixels in the segment block.

14. An image processing method as set forth in claim 12, wherein:
the threshold value set in the step of setting is an average density of the pixels in the segment block.

15. An image processing method as set forth in claim 10, wherein:
in the step of discriminating, the discrimination whether the segment block is the flat halftone region or not is performed based on density differences between adjacent pixels in the segment block.

16. An image processing method as set forth in claim 10, wherein:
the segment block is partitioned into a predetermined number of sub segment blocks; and
the discrimination whether the segment block is the flat halftone region or not is performed based on a difference(s) between average densities of the sub segment blocks in the step of discriminating.

17. An image processing program for operating an image processing apparatus comprising halftone frequency determining means for determining a halftone frequency of an inputted image,
the halftone frequency determining means comprising:
flat halftone discriminating means for extracting information of density distribution per segment block consisting of a plurality of pixels, and discriminating, based on the information of density distribution, whether the segment block is a flat halftone region in which density transition is low or of a non-flat halftone region in which the density transition is high;
extracting means for extracting a feature of density transition between pixels of the segment block which the flat halftone discriminating means discriminates as the flat halftone region; and
halftone frequency estimating means for estimating the halftone frequency, based on the feature extracted by the extracting means, and
the program causing a computer to serve as each means.

18. A computer-readable recording medium in which an image processing program for operating an image processing apparatus comprising halftone frequency determining means for determining a halftone frequency of an inputted image is stored,
the halftone frequency determining means comprising:
flat halftone discriminating means for extracting information of density distribution per segment block consisting of a plurality of pixels, and discriminating, based on the information of density distribution, whether the segment block is a flat halftone region in which density transition is low or of a non-flat halftone region in which the density transition is high;
extracting means for extracting a feature of density transition between pixels of the segment block which the flat halftone discriminating means discriminates as the flat halftone region; and
halftone frequency estimating means for estimating the halftone frequency, based on the feature extracted by the extracting means, and
the program causing a computer to serve as each means.
